(19) United States
(12) Patent Application Publication
(10) Pub. No.: US 2022/0188895 A1
(43) Pub. Date: Jun. 16, 2022

(54) PRODUCT FEATURE EXTRACTION FROM STRUCTURED AND UNSTRUCTURED TEXTS USING KNOWLEDGE BASE

(71) Applicant: Adobe Inc., San Jose, CA (US)

(72) Inventors: Nedim Lipka, Campbell, CA (US); Michele Saad, Austin, TX (US); Georgios Theocharous, San Jose, CA (US)

(73) Assignee: Adobe Inc., San Jose, CA (US)

(21) Appl. No.: 17/120,583

(22) Filed: Dec. 14, 2020

(51) Int. Cl. G06Q 30/06; G06F 40/289; G06N 5/02; G06N 5/04

(52) U.S. Cl. CPC G06Q 30/0629; G06N 5/04; G06N 5/022; G06F 40/289

(57) ABSTRACT

Unstructured texts associated with a product is received, where the unstructured texts include, for example, a title of the product, one or more reviews of the product, questions and/or answers associated with the product. A phrase in an unstructured text is identified. A first knowledge base is searched, to identify that the phrase is a feature value that is associated with a feature. For example, the first knowledge base lists the feature value to be an instance of the feature. Accordingly, a tuple is generated, where the tuple includes the product as a subject, the feature as a predicate, and the feature value comprising the phrase as an object. A second knowledge base is updated with the tuple. The second knowledge base is usable for processing queries about the product. For example, the second knowledge base is used to generate a result of a query about the product.

### FIELD OF THE DISCLOSURE

This disclosure relates generally to knowledge bases, and more specifically to techniques for extracting features for populating a knowledge base.

### BACKGROUND

Online shopping is becoming increasingly popular, with e-commerce websites selling a multitude of products over the Internet. In such web sites, a customer is able to view and research details of various products being sold, as well as compare two or more products in the same product category.

Many product comparison tools used on e-commerce web sites require structured and well-annotated product features. Such tools allow the given website to, for instance, provide various features of a product, compare features of multiple products, and process search queries in which users are looking for specific product features. Often times, this requires that similar features and/or product values of different products have the exact same names. For example, assume a first seller of a first product has marked a “current rating” of the first product to be 10 Amperes, and a second seller of a second product has marked an “Ampere rating” of the second product to also be 10 Amperes. Here, the current rating of the first product and the Ampere rating of the second product are the same. However, the product comparison tool of the e-commerce website may not know that the “current rating” and the “Ampere rating” convey the same meaning, and hence, would not be able to correctly compare the current rating of the two products. In another example, the product comparison tool of the e-commerce website may not recognize that both a “size” feature of a first product and a “dimension” feature of a second product refer to the same feature. In yet another example, the seller of the product may only identify that the product has a 10 Ampere rating, without explicitly mentioning that the 10 Ampere is actually a current rating. This may also prohibit the product comparison tools of the e-commerce website from correctly comparing the current rating of this product with the current rating of the above discussed first and second products.

Furthermore, although an e-commerce website can parse structured texts associated with a product to gather features and associated feature values of the product, the e-commerce website effectively ignores unstructured texts, which often contain useful feature information. That is, product features that occur in unstructured texts and not annotated are ignored. For example, assume that a reviewer of a product has commented that a product is “very silent” when operational. Because the “very silent” phrase occurs in unstructured text and is not correlated to a noise level in the unstructured text, a product table of the product cannot be updated to reflect a noise level of the product being “very silent” without some further action.

Thus, there exists a need to improve the manner in which product features associated with one or more products are identified, maintained, updated, and/or utilized.

### SUMMARY

Techniques are disclosed for updating and utilizing knowledge bases. For example, a method for updating and utilizing knowledge bases comprises identifying a phrase in an unstructured text that is associated with a product. The method further comprises identifying, based on searching a first knowledge base, the phrase to be a feature value that is associated with a corresponding feature. In an example, the first knowledge base lists the feature value to be an instance of the corresponding feature. The method further comprises generating, in response to identifying the phrase to be the feature value, a tuple comprising (i) the product as a subject, (ii) the feature as a corresponding predicate, and (iii) the feature value comprising the phrase as a corresponding object. A second knowledge base is updated with the tuple. Subsequently, a query associated with the product is received. A result responsive to the query is generated using the updated second knowledge base.

In another example, a system for categorizing features of products is also provided. In some embodiments, the system comprises one or more processors; a knowledge base management system executable by the one or more processors to identify a phrase in an unstructured text associated with a product. The knowledge base management system then identifies, using a first knowledge base, the phrase to be a feature value corresponding to a feature. The knowledge base management system generates a tuple comprising (i) the product as a subject, (ii) the feature as a corresponding predicate, and (iii) the feature value comprising the phrase as a corresponding object, and updated a second knowledge base with the tuple. The knowledge base management system receives a query about one or more products, and generates a result responsive to the query, using the updated second knowledge base.

In yet another example, a computer program product is provided, where the computer program product includes one or more non-transitory machine-readable mediums encoded with instructions that when executed by one or more processors cause a process to be carried out. The process includes searching texts included in a description of a product, one or more reviews of the product, one or more questions about the product, and/or one or more associated answers, to identify a phrase within the text. The process further comprises identifying, based on querying a knowledge base, the phrase to be a feature value associated with a feature of the product. The process further comprises adding, in a knowledge graph, (i) the feature value comprising the phrase as a tail node, and (ii) the feature as an edge that couples the tail node to a head node, wherein the product comprises the head node.

### BRIEF DESCRIPTION OF THE DRAWINGS

FIG. 1 is a block diagram schematically illustrating selected components of an example system comprising a computing device communicating with server device(s), where the combination of the computing device and the server device(s) are configured to generate and/or update a product knowledge base (KB), based on extracting and recognizing feature values from structured and unstructured texts associated with one or more products, in accordance with some embodiments of the present disclosure.

FIG. 2A is a flowchart illustrating an example methodology for generating and/or updating a product KB, based on extracting and recognizing feature values from structured and unstructured texts associated with one or more products, in accordance with some embodiments of the present disclosure.

FIG. 2B is a flowchart illustrating an example methodology for processing a search query using a product KB, in accordance with some embodiments of the present disclosure.

FIG. 2C is a flowchart illustrating an example methodology for processing a comparison query using a product KB, in accordance with some embodiments of the present disclosure.

FIG. 3 illustrates a KB generation and/or update module of a KB management system of a server of FIG. 1 in further detail, in accordance with some embodiments of the present disclosure.

FIG. 4A illustrates a webpage associated a product, where the webpage comprises (i) structured texts including one or more features and/or feature values and (ii) unstructured texts also including one or more other features and/or feature values, where tuples for updating a product KB are generated from both the structured and unstructured texts, in accordance with some embodiments of the present disclosure.

FIG. 4B illustrates a product table associated with multiple products, including the product of FIG. 4A, in accordance with some embodiments of the present disclosure.

FIG. 4C illustrates a product KB represented in a tabular format, as well as represented in a graphical format, where the product KB of FIG. 4C is updated based on structured texts of a product table, in accordance with some embodiments of the present disclosure.

FIG. 4D illustrates an example query for a word “Watt” in a general KB, in accordance with some embodiments of the present disclosure.

FIG. 4E illustrates an example output by the general KB, in response to the query of FIG. 4D, in accordance with some embodiments of the present disclosure.

FIG. 5A illustrates an updated product table, which is updated based on tuples generated from phrases extracted from unstructured texts, in accordance with some embodiments of the present disclosure.

FIG. 5B illustrates an updated product KB, shown in both tabular and graphical form, which is updated based on tuples generated from phrases extracted from unstructured texts, in accordance with some embodiments of the present disclosure.

FIG. 5C illustrates an example knowledge graph (KG) that is updated using tuples generated from structured and unstructured texts, in accordance with some embodiments of the present disclosure.

FIG. 5D1 illustrates example unstructured texts associated with one or more products, and

FIG. 5D2 illustrates a corresponding example KG, in accordance with some embodiments of the present disclosure.

FIG. 5D3 illustrates a section of an example product KG in which a plurality of tail nodes is updated with phrases extracted from unstructured texts (and/or possibly structured texts) and in which one or more corresponding edges are yet to be labeled, in accordance with some embodiments of the present disclosure.

FIG. 5D4 illustrates the section of the example product KG of FIG. 5D3 and a section of a general KG, wherein information from the general KG is usable to label the edges of the section of the product KG, in accordance with some embodiments of the present disclosure.

FIG. 5D5 illustrates the section of the example product KG of FIG. 5D3, with the edges appropriately labeled using information from the general KG of FIG. 5D4, in accordance with some embodiments of the present disclosure.

FIG. 6 illustrates a comparison table analyzing a category of products sold on an e-commerce website, where the comparison table is generated using a corresponding product KB, in accordance with some embodiments of the present disclosure.

FIGS. 7A and 7B collectively illustrate an example of an expansion of a product KB, based on information received from a general KB, in accordance with some embodiments of the present disclosure.

### DETAILED DESCRIPTION

Techniques are provided herein to manage, such as generate, update, and/or utilize, a product KB that is used to keep track of features and feature values of one or more products. For example, the features and corresponding feature values from both structured and unstructured texts can be used to update the product KB. Unstructured texts, as used herein, are not organized in a pre-defined manner and do not explicitly define any relationship between a feature and a corresponding feature value. Examples of such unstructured texts associated with a product include, for instance, a title of the product, a description of the product, a review of the product, one or more questions asked about the product, and/or one or more answers provided to such questions. To effectively use information included in the unstructured texts, a KB management system according to some embodiments discussed herein uses Natural Language Processing (NLP) methodologies to extract one or more phrases from the unstructured texts. In an example, the KB management system identifies, using a general KB (e.g., which is different from the product KB), an extracted phrase to be a feature value corresponding to a feature of the product. For example, the KB management system queries the general KB with the extracted phrase, to identify that the extracted phrase is a feature value corresponding to a feature of the product. A tuple is generated, which includes (i) the product as a subject or a head node, (ii) the identified feature as a predicate or an edge, and (iii) the feature value comprising the extracted phrase as an object or a tail node. The product KB is then updated with the generated tuple. As discussed herein, the product KB can be used for standardization of terminology across all products.

The product KB, which is generated and updated using techniques discussed herein, can be used for a variety of applications. For example, the product KB can be used to process a search query to find a product, or to process a compare query to compare multiple products, or to cluster and analyze different groups of products, and so on, as will be discussed in further detail herein in turn.

General Overview

As noted above, there exists a need to improve the manner in which product features associated with one or more products are identified, maintained, updated, and/or utilized. To this end, techniques are provided herein to manage (such as generate, update, and/or utilize) a knowledge base or KB that is used to keep track of features and corresponding feature values of a plurality of products belonging to a corresponding product category. Before discussing further details of example embodiments, it may be helpful to review some of the various terms as used herein.

A KB is a centralized repository where information is stored, organized, and/or shared. Two types of KBs are discussed herein: a general KB and a product specific KB. The general KB is a generic knowledge base that may or may not be tied to a specific product or a product category, and can store information about a multitude of topics. As will be discussed herein, Wikidata® is an example of such a general KB that is hosted by the Wikimedia Foundation at the website wikidata.org. Also discussed herein is a product KB that is specifically tied to a product category. As an example, discussed herein is a specific product KB that includes information about various types of blenders which are, for example, sold by an e-commerce website. Another example product KB can include information about various types of blenders which are, for example, generated by a same manufacturer. In general, a product KB includes features and corresponding feature values of individual products associated with the corresponding product category.

As discussed, a KB, such as a product KB, includes a plurality of tuples. Each tuple includes three corresponding fields, and hence, a tuple can be considered as a triple or a triplet comprising three fields of information. For example, a tuple comprises (i) a subject or a head node, (ii) a predicate or an edge, and (iii) an object or a tail node. A product KB can be stored in a tabular form or a graphical form. When stored in the tabular format (e.g., as a table or a database), each row of the table stores a corresponding tuple. For example, in the tabular form, a first column stores the various subjects, a second column stores the corresponding predicates, and a third column stores the corresponding objects of various tuples.

When stored as a computational graph, the KB is also referred to as a knowledge graph (KG). Thus, the computation graph of the KG can be visually expressed in a graphical form. In a KG, data is stored in the form of a head node (e.g., which corresponds to the above discussed subject), a tail node (e.g., which corresponds to the above discussed object), and an edge (e.g., which corresponds to the above discussed predicate) coupling a corresponding head node and a corresponding tail node. Thus, in the graphical format as well, data is stored in the form of a plurality of tuples, where an individual tuple includes the corresponding head node, the corresponding tail node, and the corresponding edge joining the head and tail nodes. In one example, a physical graph need not be drawn to represent a KG—rather, various nodes and edges of the KG can be stored, which are representative of the actual graph of the KG.

In an example, each tuple of a product KB includes (i) a product as a subject or a head node, (ii) a feature as a predicate or an edge, and (iii) a feature value as an object or a tail node. A “feature” of a product is representative of a property of the product, and a corresponding “feature value” is indicative of the corresponding value of the feature. For example, a blender can have a “current rating” as a feature, and “10 Amperes” as the feature value for the feature “current rating.” In another example, a color of the blender can be a feature, and the corresponding feature value can be, merely as an example, white or green. Thus, features and corresponding feature values of a product, which are included in the product KB, provide information about the product.

With such terms in hand, some example uses cases are now provided. As mentioned previously, techniques are provided herein to manage (such as generate, update, and/or utilize) a product KB that is used to keep track of features and feature values of multiple products belonging to a product category. In an example, the product KB can receive and store features and feature values from structured texts associated with a product. The manufacturer and/or the seller of the product updates a product table with structured information about the product. Such structured information (also referred to herein as structured texts) explicitly defines the relationship between one or more features and corresponding one or more feature values, and hence, a feature value corresponding to a feature of the product can be easily identified from the product table and used to update the product KB. In addition to such structured texts, in some embodiments, the product KB is also updated using information learnt from unstructured texts associated with the product. Unstructured texts, as used herein, are not organized in a pre-defined manner and do not explicitly define any relationship between a feature and a corresponding feature value. Example of such unstructured texts include, but are not limited to, a title of the product, a description of the product, a review of the product, one or more questions asked about the product, and/or one or more answers provided to such questions. For example, the unstructured texts can include a user review that specifies that a product is “too loud,” where, unlike structured texts, the unstructured texts do not specify that “too loud” is a feature value associated with a feature “noise level.” In order to effectively use information included in the unstructured texts, the KB management system according to an embodiment uses NLP methodologies to extract one or more phrases from the unstructured texts. The extracted phrases are then searched within a general KB that is different from the product KB. Merely as an example, the Wikidata® hosted in the wikidata.org web site is an example of a general KB. A query to such a general KB reveals whether an extracted phrase is a feature value associated with a corresponding feature of the product. For example, continuing the above discussed example use case, the general KB can identify “too loud” to be an instance of a noise level. Thus, the KB management system identifies “too loud” to be a feature value corresponding to a feature “noise level.” Accordingly, a tuple is generated, which includes (i) the product as a subject or a head node, (ii) the feature “noise level” as a predicate or an edge, and (iii) the feature value “too loud” as an object or a tail node. The product KB is then updated with the generated tuple. Similarly, various other features and corresponding feature values for the product are also included in the product KB, which can be extracted from structured texts and/or unstructured texts, thereby providing a rich repository of information associated with various features and features values of the product. The product KB also includes information about various other products in the same product category. For example, a product KB associated with blenders can include information for many different types of blenders sold on an e-commerce web site or manufactured by the same manufacturer. In case two products have the same feature value for a same feature, the two products can have a shared object or tail node. For example, assume each of a first and a second blender has a power rating of 1000 Watts. Accordingly, a first tuple of the product KB includes (i) the first product as a first head node, (ii) the feature “power” as a first edge, and (iii) the feature value “1000 Watts” as a first tail node; and a second tuple of the product KB includes (i) the second product as a second head node, (ii) the feature “power” as a second edge, and (iii) the feature value “1000 Watts” as a second tail node. Here, the first and second tail nodes (both having the value of 1000 Watts) overlap and form a common tail node, which is coupled to both the first and second head nodes via the first and second edges, respectively. In some embodiments, the product KB can be used for a variety of purposes, e.g., used to process a search query to find a product, a compare query to compare multiple products, to cluster and analyze different groups of products, and so on, as will be discussed in further detail herein in turn.

In further detail, and according to some such embodiments, the KB management system manages a product KB, and/or processes various queries using the product KB. For example, the KB management system maps structured texts from a product data repository to one or more tuples, where each tuple includes (i) a product as a subject or a head node, (ii) a feature as a predicate or an edge, and (iii) a feature value as an object or a tail node. The KB management system then updates the product KB with the generated one or more tuples. The KB management system also processes unstructured texts associated with a product, such as a title of the product, a description of the product, a review of the product, one or more questions asked about the product, and/or one or more answers provided to such questions. For example, an NLP module of the KB management system extracts one or more phrases from the unstructured texts associated with the product. Merely as an example, the unstructured texts associated with the product indicates that the product is “rated 10 Amp and 1000 W”. As “10 Amp” and “1000 Watt” are not included as structured text, the KB management system cannot readily identify these to be current and maximum power rating, respectively, for the product. For example, the KB management system may not even understand what 10 Amp and 1000 Watt represent, as these are not associated with any corresponding metadata that ideally should have identified these to be current and power rating, respectively.

In some such embodiments, the KB management system aims to correlate or link an extracted phrase (e.g., extracted by the NLP module) to a corresponding feature value and a corresponding feature. For example, the KB management system searches the above discussed general KB for the extracted phrase. In some examples, the general KB takes into account a semantic of the extracted phrases, and provides a context to the extracted phrase. The KB management system identifies, based on querying the general KB, an individual extracted phrase to be a feature value that is associated with a corresponding feature, wherein the general KB lists the feature value to be an instance of the corresponding feature. Thus, in the example where the phrase “1000 Watt” is extracted by the NLP module, the phrase “Watt” is searched within the general KB. The extracted phrase “1000 Watt” has a numerical portion “1000” and an alphabetical portion “Watt.” During the search process, the numerical portion of the phrase may be ignored. Accordingly, the word “Watt” is searched, to determine whether this word is a feature value that has a corresponding feature. An appropriate query language can be used to search the general KB for the word “Watt.” In an example, the general KB outputs a query result, which indicates that the word “Watt” (or an identifier that identifies the word “Watt”) is, among other things, an instance of an SI derived unit, and an instance of a unit of power. So, now the KB management system knows that the word “Watt” is an instance of a unit of power. Accordingly, the KB management system can now deduce that the phrase “1000 Watt” is a feature value that is an instance of, or associated with, a corresponding feature “power.” In another example, the KB management system can similarly deduce that another extracted phrase “too loud” is a feature value that is an instance of a corresponding feature “noise level.”

For example, based on the example use case scenario discussed above, the KB management system generates a tuple comprising (i) the product as a corresponding subject or head node, (ii) the feature “power” as a corresponding predicate or edge, and (iii) the feature value “1000 Watt” as a corresponding object or tail node. Similarly, the KB management system generates another tuple comprising (i) the product as a corresponding subject or head node, (ii) the feature “noise level” as a corresponding predicate or edge, and (iii) the feature value “too loud” as a corresponding object or tail node. In a similar manner, the KB management system generates other tuples corresponding to other feature/feature value pairs extracted from the unstructured texts. Subsequently, the KB management system updates the product KB with the generated tuples that are extracted from the unstructured texts.

In some such embodiments, the tuples can be modified prior to updating the product KB. For example, assume that in one of the tuples, power is represented in the unit of “Watt,” where a unit of power used universally in the product KB 110 can be, for example, “W”. Thus, the feature value “1000 Watt” is updated to “1000 W,” prior to updating the product KB 110.

In another example, every product (e.g., every shirt) included in the product KB uses “size” as a feature. If a manufacturer lists a product with “dimension” instead of “size,” the KB management system realizes that “dimension” is not a listed feature. Accordingly, the KB management system searches the general KB, to determine that “dimension” and “size” refer to the same feature. Accordingly, the feature name is changed from “dimension” to “size” before the corresponding feature value (such as “XL” or “L”) is added to the product KB. This way, the product KB can be used for standardization of terminology across all products within the product KB.

Another example of modification of a tuple can be conversion of units, where, for example, a tuple can include a feature value in “inches,” whereas the product KB stores the feature values in foot or centimeter (cm). In such an example, the feature value in inches undergoes appropriate conversion, before being included in the product KB.

Generating and/or updating the product KB, using feature values from both structured and unstructured texts, makes the product KB richer with relevant features. For example, without the KB management system, the tuples generated from the unstructured texts would not ordinarily have been present in the product KB. However, the KB management system is able to extract feature values from the unstructured texts and able to update the product KB.

The product KB generated by the KB management system can be used in a variety of applications. For example, the product KB can be used to process a search query. For example, assume that the KB management system receives a search query to search for products, where the query includes one or more feature values. In an example use case where the products being searched are blenders, the search query can be for searching a blender having, merely as an example, 6 speed levels and/or one or more other feature values that a user generally looks for in a blender. In the product KB, merely as an example, a first blender and a second blender (but not a third blender) have 6 speed levels. Accordingly, the KB management system extracts information associated with the identified first and second blenders from the product KB, and outputs the query results for display.

In another example, assume that the KB management system receives a comparison query to compare at least two products, where the two products in the product KB have a first feature having a common feature value, and a second feature having two different feature values corresponding to the two products. In the above discussed example use case where the product KB includes at least three blenders, assume that the comparison query is to compare the first and second blender models. There is at least a first feature having a common feature value for the two queried products. For example, assume that both the first and second blenders are 6-speed blenders, and have 10,000 rpm maximum speed. Thus, each of the features “maximum speed” and “number of speed levels” has the same corresponding feature value for both the products. On the other hand, there is at least a second feature that has different feature values for the two products. For example, the first and second blenders have “low” noise level and “too loud” noise level, respectively. Accordingly, the KB management system searches the associated product KB and generates a comparison table comparing the two products. The comparison table has at least (i) a first row illustrating the first feature having the common feature value, and (ii) a second row illustrating the second feature having two different feature values corresponding to the two products being compared. Thus, for example, the first row illustrates the number of speed levels, and also illustrates that both blenders are 6-speed blenders. Furthermore, a second row (where the first and second rows need not be consecutive rows) illustrates that the first and second blenders have low noise level and too loud noise level, respectively. The comparison table is then output for display.

Numerous other applications of the product KB are also discussed herein and will be appreciated based on the teachings of this disclosure.

System Architecture

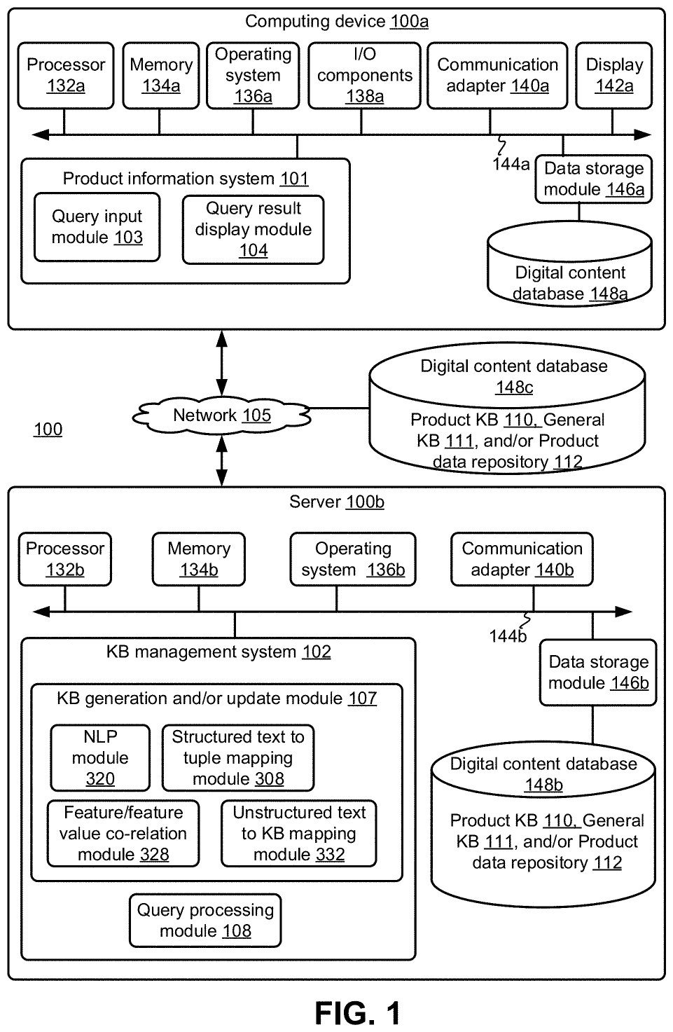

FIG. 1 is a block diagram schematically illustrating selected components of an example system 100 comprising a computing device 100a communicating with server device(s) 100b, where the combination of the computing device 100a and the server device(s) 100b (henceforth also referred to generally as server 100b) are configured to generate and/or update a product KB, based on extracting and recognizing feature values from structured and unstructured texts associated with one or more products, in accordance with some embodiments of the present disclosure. As can be seen, the device 100a includes a product information system 101 (also referred to as system 101) and the servers 100b includes a KB management system 102 (also referred to as system 102), which allow the system 100 to manage one or more product KBs and provide product information based on such managed product KBs, as will be discussed in turn.

As will be appreciated, the configuration of the device 100a may vary from one embodiment to the next. To this end, the discussion herein will focus more on aspects of the device 100a that are related to managing product information, and less so on standard componentry and functionality typical of computing devices. The device 100a comprises, for example, a desktop computer, a laptop computer, a workstation, an enterprise class server computer, a handheld computer, a tablet computer, a smartphone, a set-top box, a game controller, and/or any other computing device that can query for product information and cause display of one or more query results.

In the illustrated embodiment, the device 100a includes one or more software modules configured to implement certain functionalities disclosed herein, as well as hardware configured to enable such implementation. These hardware and software components may include, among other things, a processor 132a, memory 134a, an operating system 136a, input/output (I/O) components 138a, a communication adaptor 140a, data storage module 146a, and the product information system 101. A digital content database 148a (e.g., that comprises a non-transitory computer memory) stores one or more queries, and/or results of the queries that are to be displayed, and is coupled to the data storage module 146a. A bus and/or interconnect 144a is also provided to allow for inter- and intra-device communications using, for example, communication adaptor 140a. In some embodiments, the system 100 includes a display screen 142a (referred to simply as display 142a), although in some other embodiments the display 142a can be external to and communicatively coupled to the system 100a. Note that in an example, components like the operating system 136a and the product information system 101 can be software modules that are stored in memory 132a and executable by the processor 132a. In an example, at least sections of the product information system 101 can be implemented at least in part by hardware, such as by Application-Specific Integrated Circuit (ASIC) or microcontroller with one or more embedded routines. The bus and/or interconnect 144a is symbolic of all standard and proprietary technologies that allow interaction of the various functional components shown within the device 100a, whether that interaction actually take place over a physical bus structure or via software calls, request/response constructs, or any other such inter and intra component interface technologies, as will be appreciated.

Processor 132a can be implemented using any suitable processor, and may include one or more coprocessors or controllers, such as an audio processor or a graphics processing unit, to assist in processing operations of the device 100a. Likewise, memory 134a can be implemented using any suitable type of digital storage, such as one or more of a disk drive, solid state drive, a universal serial bus (USB) drive, flash memory, random access memory (RAM), or any suitable combination of the foregoing. Operating system 136a may comprise any suitable operating system, such as Google Android, Microsoft Windows, or Apple OS X. As will be appreciated in light of this disclosure, the techniques provided herein can be implemented without regard to the particular operating system provided in conjunction with device 100a, and therefore may also be implemented using any suitable existing or subsequently-developed platform. Communication adaptor 140a can be implemented using any appropriate network chip or chipset which allows for wired or wireless connection to a network and/or other computing devices and/or resource. The device 100a also include one or more I/O components 138a, such as one or more of a tactile keyboard, the display 142a, a mouse, a touch sensitive or a touch-screen display (e.g., the display 142a), a trackpad, a microphone, a camera, scanner, and location services. In general, other standard componentry and functionality not reflected in the schematic block diagram of FIG. 1 will be readily apparent, and it will be further appreciated that the present disclosure is not intended to be limited to any specific hardware configuration. Thus, other configurations and subcomponents can be used in other embodiments.

Also illustrated in FIG. 1 is the product information system 101 implemented on the device 100a. In an example embodiment, the system 101 includes a query input module 103 and a query result display module 104, each of which will be discussed in detail in turn. In an example, the components of the system 101 are in communication with one another or other components of the device 100a using the bus and/or interconnect 144a, as will be discussed in further detail in turn. The components of the system 101 can be in communication with one or more other devices including other computing devices of a user, server devices 100b, cloud storage devices, licensing servers, or other devices/systems. Although the components of the system 101 are shown separately in FIG. 1, any of the subcomponents may be combined into fewer components, such as into a single component, or divided into more components as may serve a particular implementation.

In an example, the components of the system 101 performing the functions discussed herein with respect to the system 101 may be implemented as part of a stand-alone application, as a module of an application, as a plug-in for applications, as a library function or functions that may be called by other applications, and/or as a cloud-computing model. Thus, the components of the system 101 may be implemented as part of a stand-alone application on a personal computing device or a mobile device. Alternatively, or additionally, the components of the system 101 may be implemented in any application that allows initiation of a query and causing display of the query results.

In an example, the communication adaptor 140a of the device 100a can be implemented using any appropriate network chip or chipset allowing for wired or wireless connection to network 105 and/or other computing devices and/or resources. To this end, the device 100a is coupled to the network 105 via the adaptor 140a to allow for communications with other computing devices and resources, such as the server 100b and/or a remote or cloud-based digital content database 148c. The network 105 is any suitable network over which the computing devices communicate. For example, network 105 may be a local area network (such as a home-based or office network), a wide area network (such as the Internet), or a combination of such networks, whether public, private, or both. In some cases, access to resources on a given network or computing system may require credentials such as usernames, passwords, or any other suitable security mechanism.

In one embodiment, the server 100b comprises one or more enterprise class devices configured to provide a range of services invoked to provide management of product KBs, such as generation and updating of the product KBs and/or processing queries using the product KBs, as variously described herein. In some embodiments, the server 100b comprises a KB management system 102b providing such services, as variously described herein. Although one server implementation of the system 102 is illustrated in FIG. 1, it will be appreciated that, in general, tens, hundreds, thousands, or more such servers can be used to manage an even larger number of KB management functions.

In the illustrated embodiment, the server 100b includes one or more software modules configured to implement certain of the functionalities disclosed herein, as well as hardware configured to enable such implementation. These hardware and software components may include, among other things, a processor 132b, memory 134b, an operating system 136b, the KB management system 102 (also referred to as system 102), data storage module 146b, and a communication adaptor 140b. A digital content database 148b (e.g., that comprises a non-transitory computer memory) comprises a product KB 110, a general KB 111, and/or product data repository 112, and is coupled to the data storage module 146b. A bus and/or interconnect 144b is also provided to allow for inter- and intra-device communications using, for example, communication adaptor 140b and/or network 105. Note that components like the operating system 136b and system 102 can be software modules that are stored in memory 134b and executable by the processor 132b. The previous relevant discussion with respect to the symbolic nature of bus and/or interconnect 144a is equally applicable here to bus and/or interconnect 144b, as will be appreciated.

Processor 132b is implemented using any suitable processor, and may include one or more coprocessors or controllers, such as an audio processor or a graphics processing unit, to assist in processing operations of the server 100b. Likewise, memory 134b can be implemented using any suitable type of digital storage, such as one or more of a disk drive, a universal serial bus (USB) drive, flash memory, random access memory (RAM), or any suitable combination of the foregoing. Operating system 136b may comprise any suitable operating system, and the particular operation system used is not particularly relevant, as previously noted. Communication adaptor 140b can be implemented using any appropriate network chip or chipset which allows for wired or wireless connection to network 105 and/or other computing devices and/or resources. The server 100b is coupled to the network 105 to allow for communications with other computing devices and resources, such as the device 100a. In general, other componentry and functionality not reflected in the schematic block diagram of FIG. 1 will be readily apparent in light of this disclosure, and it will be further appreciated that the present disclosure is not intended to be limited to any specific hardware configuration. In short, any suitable hardware configurations can be used.

The server 100b can generate, store, receive, and transmit any type of data, including one or more product KBs and/or queries that are to be processed using such product KBs. As shown, the server 100b includes the system 102 that communicates with the system 101 on the client device 100a. In an example, the KB management features can be implemented exclusively by the system 102, and/or at least in part by the systems 101 and 102. The system 102 comprises a KB generation and/or update module 107 and a query processing module 108, each of which will be discussed in detail in turn.

In some examples, the system 100 also includes a remote or cloud-based digital content database 148c that comprises a non-transitory computer memory. The digital content database 148c can also store the product KB 110, the general KB 111, and/or the product data repository 112, and is coupled to the server 100b via the network 105.

In an example, the system 102 comprises an application running on the server 100b or a portion of a software application that can be downloaded to the device 100a. For instance, the system 102 can include a web hosting application allowing the device 100a to interact with content from the system 102 hosted on the server 100b. Thus, the location of some functional modules in the system 100b may vary from one embodiment to the next. For instance, while the query processing module 108 is shown on the server side in this example case, the query processing module 108 can be duplicated on the client side as well (e.g., within the system 101) in other embodiments. Any number of client-server configurations will be apparent in light of this disclosure. In still other embodiments, the techniques may be implemented entirely on a user computer, e.g., simply as stand-alone query processing application. Similarly, while the digital content database 148b is shown on the server side in this example case, it may be located remotely from the server, such as the cloud-based database 148c. Thus, the database of the digital content can be local or remote to the server 100b, so long as it is accessible by the modules implemented by the system 102 and/or implemented by the system 101.

Example Operation

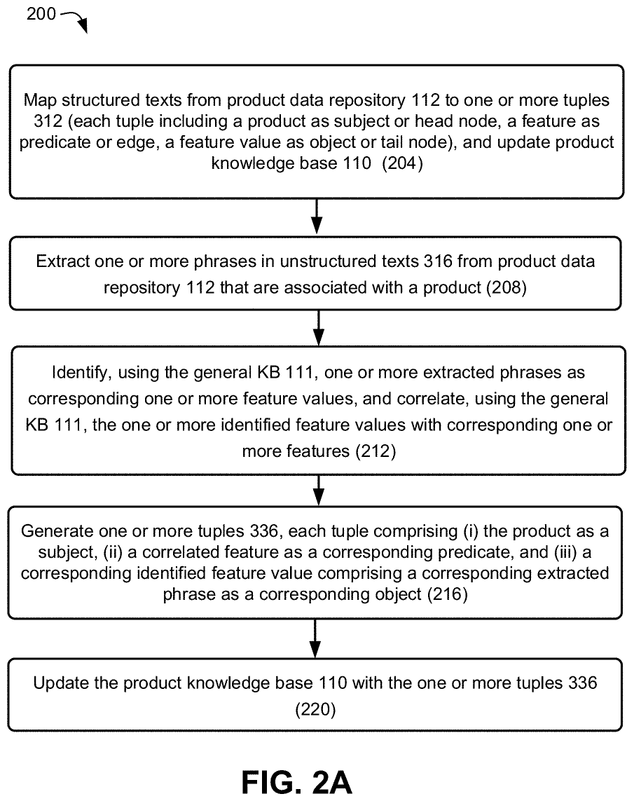

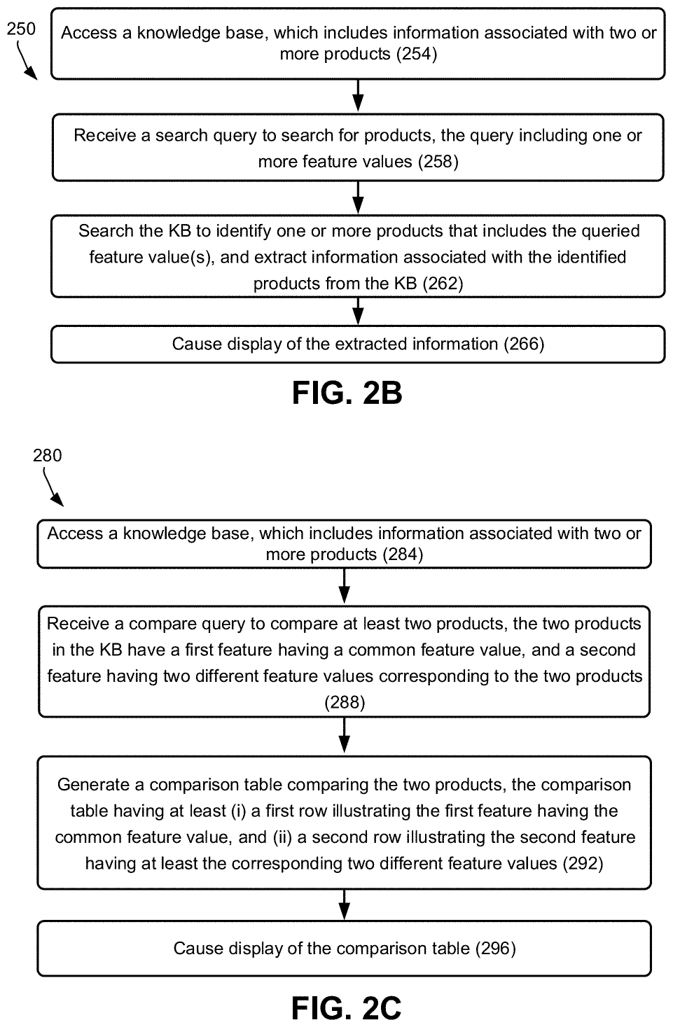

FIG. 2A is a flowchart illustrating an example methodology 200 for generating and/or updating a product KB 110, based on extracting and recognizing feature values from structured and unstructured texts associated with one or more products, in accordance with some embodiments of the present disclosure. Method 200 can be implemented, for example, using the system architecture illustrated in FIG. 1, and described herein. However other system architectures can be used in other embodiments, as apparent in light of this disclosure. To this end, the correlation of the various functions shown in FIG. 2A to the specific components and functions illustrated in FIG. 1 is not intended to imply any structural and/or use limitations. Rather, other embodiments may include, for example, varying degrees of integration wherein multiple functionalities are effectively performed by one system. In another example, multiple functionalities may be effectively performed by more than one system. Although various operations of the method 200 are discussed herein as being performed at least in part by the system 102 of FIG. 1 (e.g., by the KB generation and/or update module 107 of the system 102), one or more of these operations can also be performed by the system 101 as well.

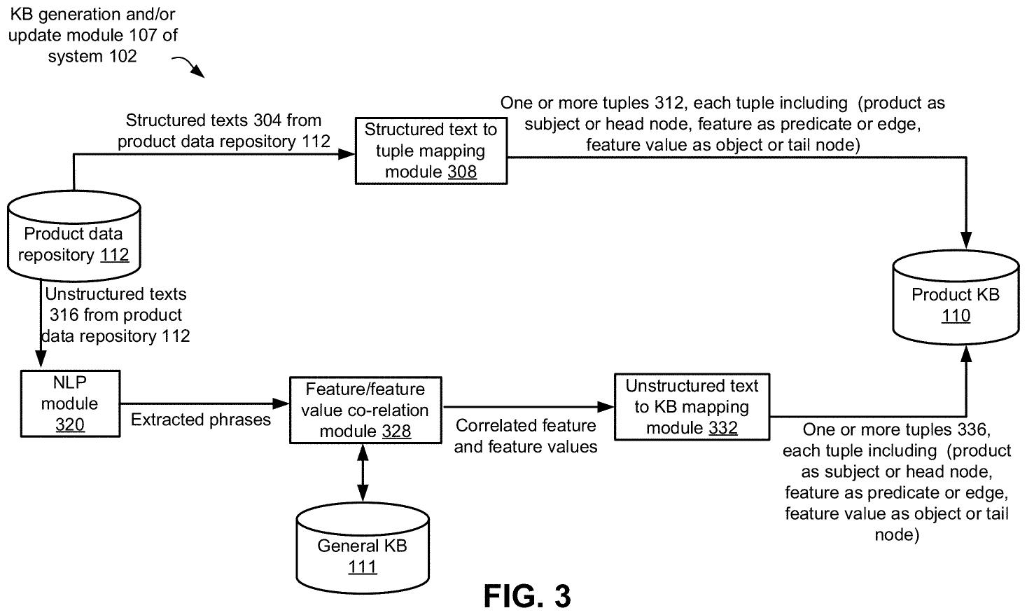

FIG. 3 illustrates the KB generation and/or update module 107 of the KB management system 102 of the server 100b of FIG. 1 in further detail, in accordance with some embodiments of the present disclosure. FIGS. 2A and 3 will be discussed in unison herein.

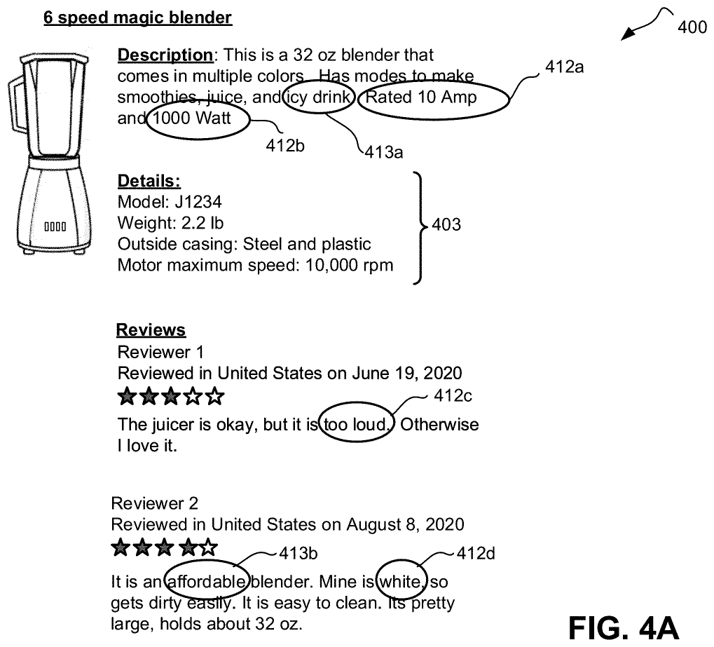

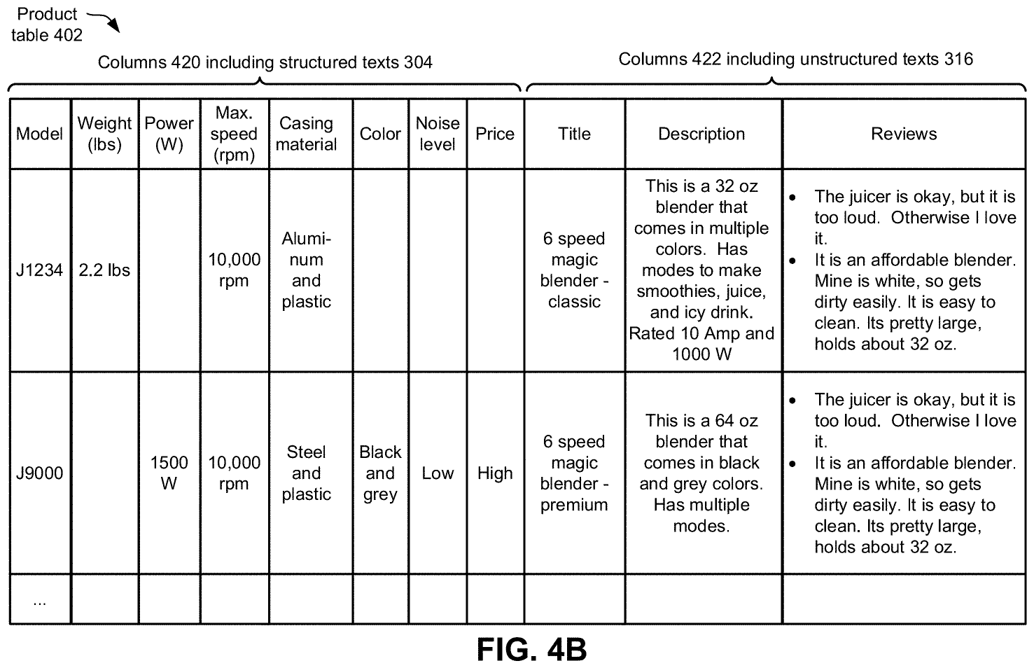

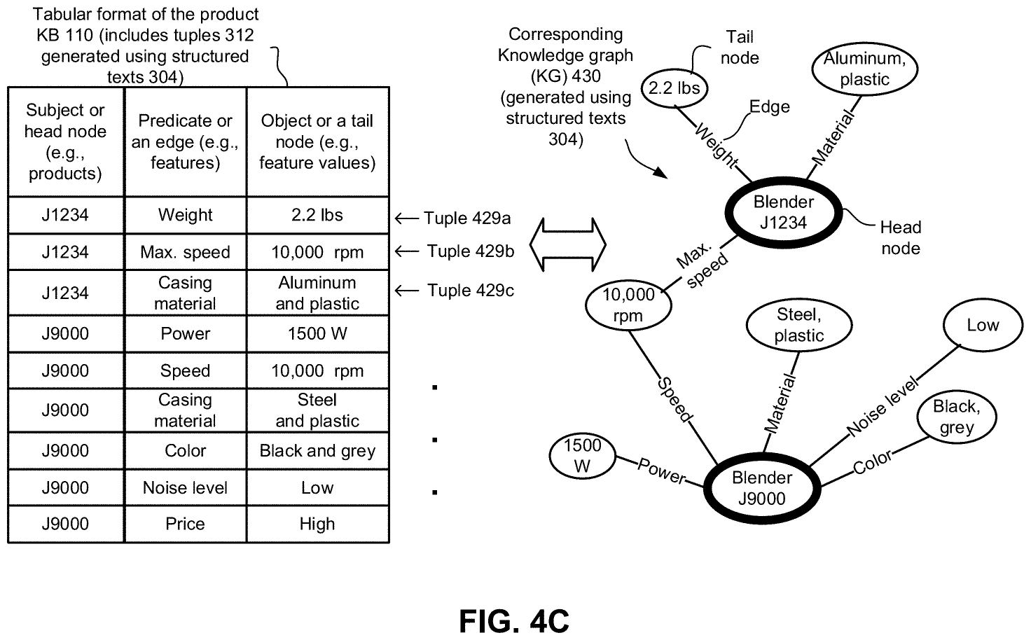

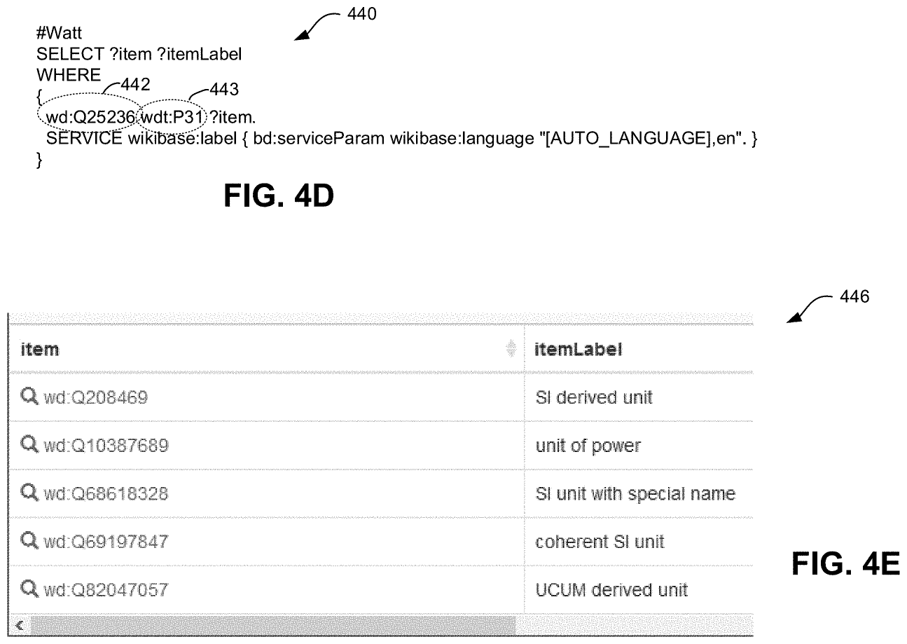

Referring to FIG. 2A, at 204 of the method 200, the module 107 (such as the structured text to tuple mapping module 308 illustrated in FIG. 3) maps structured texts 304 from the product data repository 112 to one or more tuples 312, where each tuple includes (i) a product as a subject or a head node, (ii) a feature as a predicate or an edge, and (iii) a feature value as an object or a tail node, as also illustrated in FIG. 3. Also at 204, the module 107 (such as the structured text to tuple mapping module 308) updates the product KB 110 with the generated one or more tuples 312. For example, as illustrated in FIG. 3, the structured text to tuple mapping module 308 of the system 102 receives the structured text 304 from the product data repository 112, and maps the structured text 304 to the one or more tuples 312. These operations are discussed herein below with respect to FIGS. 4A, 4B, and 4C.

FIG. 4A illustrates a webpage 400 associated a product, where the webpage comprises (i) structured texts including one or more features and/or feature values and (ii) unstructured texts also including one or more other features and/or feature values, where tuples for updating a product KB are generated from both the structured and unstructured texts, in accordance with some embodiments of the present disclosure. The webpage 400 can be, for example, a webpage of an e-commerce website selling the product. FIG. 4B illustrates a product table 402 associated with multiple products, including the product of FIG. 4A, in accordance with some embodiments of the present disclosure.

Referring to FIG. 4A and the first row of the product table 402 of FIG. 4B, described is a product that is, for example, a blender having a model number J1234. In some embodiments, the product data repository 112 includes product information depicted in FIGS. 4A and 4B. For example, the first row of the table 402 of FIG. 4B includes details of the product having the model number J1234, which corresponds to the blender of FIG. 4A. The second row of the table 402 of FIG. 4B includes details of another product having model number J9000, which is another blender. The product table 402 is specifically for blenders, for example. Although information associated with merely two products are illustrated in table 402, the table 402 can include information about any appropriate number of products, such as three, ten, one hundred, or any other appropriate number of blenders.

The multiple columns of the table 402 of FIG. 4B are divided into two categories: columns 420 that include structured texts 304, and columns 422 that include unstructured texts 316. Structured texts are written content that are associated with corresponding metadata, and can readily be indexed or mapped onto standard database fields. For the example products discussed with respect to FIGS. 4A and 4B, the columns 420 including the structured texts are associated with model, weight, power (in Watt, referred to herein as “W” as well), maximum speed (in revolutions per minute or rpm), casing material, color, noise level, and price. These are mere examples and specific to the example product blender, and these column items are implementation specific and can change based on the actual product being analyzed, and can include fewer or greater number of columns. FIG. 4A illustrates details 403 of the product in a structured text format, such as a model, a weight, a material of outside casing, and a maximum speed of a motor. These are features of the product, and have corresponding feature values. For example, the feature “weight” has a corresponding feature value of 2.2 lbs. The details section 403 of the webpage 400 includes structured texts, as the features and the corresponding feature values included in the details section 403 are stored as structured texts in the first row of the product table 402.

The product table 402 also includes columns 422 that include unstructured texts 316. Unstructured texts (or unstructured information) are information that either do not have a pre-defined data model or are not organized in a pre-defined manner. Unstructured information is typically text-heavy, but may contain data such as dates, numbers, and facts as well. This results in irregularities and ambiguities that make it difficult to understand data included in unstructured texts using traditional computer programs, as compared to structured data stored in fielded form in databases or annotated (semantically tagged) in documents. Thus, the unstructured text in the columns 422 are written content that lacks metadata and cannot readily be indexed or mapped onto standard database fields. Examples of unstructured texts 316 in the columns 422 include title of the products, description of the products, and/or user reviews of the products, as illustrated in FIG. 4B. Although not illustrated in FIGS. 4B and 4B, examples of unstructured texts 316 can also include one or more customer-generated questions raised about the product in the e-commerce website and/or one or more customer-provided (or manufacturer or seller provided) answers to such question(s).

Thus, referring now to FIGS. 2A, 3, 4A, and 4B, at 204 of the method 200, the structured text to tuple mapping module 308 maps the structured texts 304 from the product data repository 112 to one or more tuples 312. Here, the structured texts 304 refer to the texts in the columns 420 of the product table 402. As discussed, each tuple includes (i) the product as a subject or a head node, (ii) a feature as a predicate or an edge, and (iii) a feature value as an object or a tail node. For example, referring to the second column and first row of the table 402, a first tuple would be (i) the product having the model number J1234, which forms the subject or the head node, (ii) the feature weight, which forms the predicate or the edge, and (iii) the feature value 2.2 lbs (pounds), which forms the object or the tail node of the tuple. The first tuple can also be represented as (J1234, weight, 2.2 lbs). An example second tuple would be (J9000, power, 1500 W), corresponding to the product J9000, the feature “power,” and the corresponding feature value of 1500 W (Watt). Similarly, other tuples are generated based on information included in the column 420 of the product table 402. Note that, for example, the feature value corresponding to the feature “power” is missing for the product J1234, and hence, no tuple is formed corresponding to this feature and for this product.

Subsequently, also at 204 of the method 200, the product KB 110 is updated using the tuples 312 formed at 204. The product KB 110 stores information using the tuples. For example, FIG. 4C illustrates the product KB 110 represented in a tabular format, as well as represented in a graphical format, where the product KB 110 of FIG. 4C is updated based on structured texts 304 of the product table 402 of FIG. 4B, in accordance with some embodiments of the present disclosure. For example, left side of FIG. 4C illustrates the KB 110 represented in the tabular format. Also illustrated in the right side of FIG. 4C is the corresponding knowledge graph 430, which is a graphical representation of the product KB 110. The tabular and the graphical format of the product KB 110 represent similar information, in some examples. Thus, a product KB can be represented in a tabular format, or as a KG in a graphical format.

The product KB 110 of FIG. 4C is generated using tuples 312 mapped from the structured texts 304 of the product table 402. Thus, the product KB 110 of FIG. 4C is generated and/or updated by the structured text to tuple mapping module 308 of FIG. 3, and is output at 204 of method 200 of FIG. 2. The first column of the tabular format of the KB 110 comprises various products represented as subjects of the product KB 110, which also form head nodes in the KG 430. The second column includes features, represented as predicates, which form corresponding edges in the KG 430. The third column includes feature values, represented as objects, which form corresponding tail nodes in the KG 430.

The KG 430 comprises various nodes. Some nodes are head nodes and some are tail nodes. The head nodes are illustrated using relatively thick lines, and the tail nodes are illustrated using relatively thin lines. Various products from the first column of the table form the head nodes, such as the nodes labeled as “J1234” and “J9000” corresponding to the two example blenders discussed herein. The tail nodes include feature values, such as 2.2 lbs, 10,000 rpm, and so on.

Individual edges of the KG 430 couples a head node to a corresponding tail node. For example, a first row of the tabular form of the KB 110 comprises a tuple 429a, which can be represented as (J1234, weight, 2.2 lbs). Thus, an edge representing the feature weight couples the head node (comprising the blender J1234) to the corresponding feature value or tail node of 2.2 lbs.

Note that both the products J1234 and J9000 in the KB 110 have the same maximum speed of 10,000 rpm. Accordingly, in the KG 430, the tail node including the feature value 10,000 rpm is coupled to both head nodes J1234 and J9000 via corresponding edges representing maximum speed.

Note that, for example, the blender J1234 has aluminum and plastic as its material, and the blender J9000 has steel and plastic as its material. Accordingly, there are two edges representing the feature “material” in the KG 430—one coupling the product J1234 with the corresponding feature value aluminum and plastic, and another coupling the product J9000 with the corresponding feature value steel and plastic. Other features are similarly represented in the KG 430.

Referring again to FIG. 2A, the method 200 then proceeds from 204 to 208, where the NLP module 320 of the system 102 (illustrated in FIG. 3) extracts one or more phrases from the unstructured texts 316 from the product data repository 112 associated with the product. For example, as discussed with respect to FIG. 4B, columns 422 of the product table 402 include unstructured texts 316. As illustrated in FIGS. 4A and 4B, examples of such unstructured texts 316 include a title of a product, description of the product, user reviews of the product, one or more questions asked about the product, and/or one or more answers provided to such questions.

For example, the description of the product J1234 indicates that the product J1234 is “rated 10 Amp and 1000 W,” labelled as 412a and 412b in FIG. 4A. This indicates that the product J1234 has a current rating of 10 Ampere or Amp, and has a power rating of 1000 Watt. Ideally, such information should have been included as structured texts in the product table 402. However, although the manufacturer has updated the product description, the manufacturer may not have updated the structured texts 304 of the product table 402 with such information. Furthermore, as 10 Amp and 1000 Watt are not included as structured text, the structured text to tuple mapping module 308 cannot readily identify these to be current and maximum power rating, respectively, for the blender J1234. For example, the module 308 may not even understand what 10 Amp and 1000 Watt represent, as these are not associated with any corresponding metadata that ideally should have identified these to be current and power rating, respectively. Other example of useful information included in the unstructured texts 316 includes the juicer being “too loud” (labeled as 412c within a user review of the J1234 product in the webpage 400), and the blender being “white” (labeled as 412d within another user review of the J1234 product in the webpage 400).

Thus, at 208, the NLP module 320 extracts phrases, such as “10 Amp,” “1000 W,” “too loud,” and “white.” Many other phrases, such as “icy drink” and “affordable” are also extracted (labeled as 413a and 413b, respectively, in the webpage 402 of FIG. 4A), although such phrases may not be used to update any product KB, as will be discussed.

For example, a numerical value (such as “10” labelled in 412a of FIG. 4A) is identified in the unstructured text. Subsequently, one or more words preceding or succeeding the numerical value (such as “Amp” that succeeds the “10”) are also identified, and the numerical value and the associated words are identified and extracted as a phrase in the unstructured text. In some other examples, other words or phrases, such as “icy drink,” “too loud,” and so on are also extracted.

Referring again to FIG. 2A, the method 200 then proceeds from 208 to 212, where the module 107 (such as the feature/feature value co-relation module 328 illustrated in FIGS. 1 and 3) identifies (e.g., using the general KB 111) one or more extracted phrases as corresponding one or more feature values, and correlates (e.g., using the general KB 111) the one or more identified feature values with corresponding one or more features. Thus, an extracted phrase is identified to be a corresponding feature vale, and the feature vale is linked to a corresponding feature. For example, an extracted phrase is “1000 Watt,” and the NLP module may not know that 1000 Watt (or Watt) is representative of a power value or a power rating. At 212, the feature/feature value co-relation module 328 identifies that “Watt” is a feature value, and correlates or links the “Watt” feature value to a corresponding feature “power.”

In one example, simple heuristics is used to identify the feature values, e.g. by looking for numeric values and/or by considering all words as feature value candidates. Thus, 10 Amp, 1000 Watt, and other words having a numerical value (such as 32 oz, which is also a feature value) are identified as being possible candidate feature values. Similarly, other words or phrases, such as “icy drink,” “too loud,” and so on are also considered as candidate feature values.

An entity linking methodology is used to identify entities in the text field, disambiguate such entities, and link such entities to an existing general knowledge graph, such as the general KB 111. The general KB 111 may not be tied to the products being considered, and hence, the KB 111 is also referred to herein as a “general” KB. In contrast, the product KB 110 is a domain specific KB that may be tied to a certain category of products.

An example of such a general KB 111 is the Wikidata® KB. Wikidata® is a collaboratively edited multilingual knowledge graph hosted by the Wikimedia Foundation at the website wikidata.org. It is a common source of open data that Wikimedia projects such as Wikipedia, and anyone else, can use under a public domain license. Wikidata® is powered by the software Wikibase. Wikidata® acts as central storage for the structured data of its Wikimedia sister projects, such as the Wikipedia. Although Wikidata® is used as an example of a general KB here, any other appropriate publicly available, or privately developed or held knowledge base or knowledge graph can be used in other examples for the general KB 111.

In some examples, the general KB 111 takes into account a semantic of the extracted phrases (e.g., as extracted by the NLP module 320), and provides a context to the extracted phrase. In a KB, such as the general KB 111, individual entries are assigned corresponding unique identifiers. For example, in Wikidata®, a QID (or a Q number) is the unique identifier of a data item, comprising the letter “Q” followed by one or more digits. It is used to help people and machines understand the difference between items with the same or similar names. For example, “London”, the capital of United Kingdom, is represented by a corresponding QID Q84; whereas “London,” a city in Southwestern Ontario, Canada, is represented by a corresponding QID Q92561. The unique identified appears next to the name at the top of each Wikidata® item.

The operations for identification and correlation included in block 212 can be, for example, implemented by searching (e.g., by the feature/feature value co-relation module 328) for the extracted one or more phrases in the general KB 111, and identifying an individual phrase to be a feature value that is associated with a corresponding feature, wherein the general KB 111 lists the feature value to be an instance of the corresponding feature.

Thus, if “1000 Watt” is identified and extracted at 208, at 212, the phrase “Watt” is searched within the general KB 111. Thus, the extracted phrase “1000 Watt” has a numerical portion “1000” and an alphabetical portion “Watt.” During the search process, the numerical portion of the phrase is ignored in an example. Accordingly, the word “Watt” is searched, to determine whether this word is a feature value that has a corresponding feature. An initial search of the general KB 111, such as the Wikidata® KB, reveals that the word “Watt” has a corresponding unique identifier or QID Q13565117. Subsequently, a query is generated using this QID. Any appropriate KB query service can be used. In an example where Wikidata® is used as the general KB 111, “Wikidata® Query Service” is used to query the general KB 111. If a different general KB is used, the query service can be changed accordingly. For example, the Wikidata® Query Service uses SPARQL, which is a recursive acronym for SPARQL Protocol and RDF Query Language. SPARQL is an RDF query language (e.g., a semantic query language for databases), which is able to retrieve and manipulate data stored in a Resource Description Framework (RDF) format. The SPARQL was made a standard by the RDF Data Access Working Group (DAWG) of the World Wide Web Consortium, and is recognized as one of the key technologies of the semantic web.

For example, FIG. 4D illustrates an example query 440 for the word “Watt” in the general KB 111 (such as a query in the Wikidata® KB), in accordance with some embodiments of the present disclosure. FIG. 4E illustrates an example output 446 by the general KB 111, in response to the query of FIG. 4D, in accordance with some embodiments of the present disclosure. The query 440 can be input in the website https://query.wikidata.org/, which provides the query output 446 of FIG. 4E. In some examples, the feature/feature value co-relation module 328 can use an appropriate Application Program Interface (API) to input the query 440 and receive the corresponding output 446.

Referring to FIG. 4D, the query 440 includes a QID Q25236 of the word “Watt” (labelled as 442 in FIG. 4D), which is to indicate that the query 440 is for the word “Watt.” In general, a QID in the query 440 is prefixed with “wd:”, as illustrated by the label 442 in FIG. 4D. Furthermore, a property of the query is prefixed with a “wdt:” as indicated by the label 443 in FIG. 4D. For example, the property being queried as “P31,” which is the following “instance of (P31): that class of which this subject is a particular example and member.” Thus, the query 440 aims to find out one or more classes, of which the item associated with the QID Q25236 is an instance or a particular example or member.

As illustrated in the query output 446, the general KB 111 indicates that the QID Q25236 (i.e., the word Watt) is, among other things, an instance of an SI derived unit, and an instance of a unit of power. So, now the feature/feature value co-relation module 328 knows that the word “Watt” is an instance of a unit of power. Accordingly, the feature/feature value co-relation module 328 can now deduce that the phrase “1000 Watt” is a feature value that is an instance of, or associated with, a corresponding feature “power.”

Similarly, referring to FIGS. 4A, 4D, and 4E, the feature/feature value co-relation module 328 can also determine that the phrase “10 Amp” (e.g., see label 412a of FIG. 4A) is a feature value that is an instance of a corresponding feature “current”; the phrase “too loud” (e.g., see label 412c of FIG. 4A) is a feature value that is an instance of a corresponding feature “noise level”; and the word “white” (e.g., see label 412d of FIG. 4A) is a feature value that is an instance of a corresponding feature “color.” For example, FIG. 3 illustrates the feature/feature value co-relation module 328 correlating various features and corresponding feature values, e.g., correlating the extracted phrase “1000 Watt” to “power,” correlating the extracted phrase “10 Amp” to “current,” correlating the extracted phrase “too loud” to “noise,” and correlating the extracted phrase “white” to “color,” in some examples.

It may be noted that not all phrases extracted at 208 of the method 200 can be identified to be a feature value. For example, as illustrated in FIG. 4A, the phrase “icy drink” (e.g., see label 413a of FIG. 4A) and the word “affordable” (e.g., see label 413b of FIG. 4A) may not be identified by the general KB 111 as being a feature value. For example, the phrase “icy drink” may not be a feature value at all, as it may not describe a feature of the blender itself. Furthermore, although the word “affordable” is a feature value corresponding to a feature “price,” the general KB 111 (such as the Wikidata®) may not readily identify “affordable” to be a feature value for price. For example, a search of the Wikidata® KB using “affordable” outputs “Affordable care Act” and “Affordable housing,” but does not readily identify “affordable” to be a feature value of a feature “price”. However, some other general KB may identify “affordable” to be a feature value of a feature “price,” and such details are implementation specific

As discussed, in some examples, the general KB 111 links or correlates an extracted phrase to a corresponding feature and a feature value. Accordingly, the general KB 111 is also referred to herein as a linking entity performing linking operations.

As discussed, the general KB is a generic knowledge base that may or may not be tied to a specific product or a product category, and can store information about a multitude of topics. In some examples, the general KB can also be trained with some domain specific knowledge as well. Merely as an example, if the general KB is used for various products used in shipping industry, a domain specific KB that has terms used in the shipping industry can be used as the general KB. In an example, the general KB is trained to acquire the domain specific knowledge. For example, transfer learning techniques can be used to train the general KB, to acquire the domain specific knowledge. In some such examples, the general KB can have the domain specific knowledge, but may not be directed towards a specific product or a specific product category within the specific domain. For example, assume a product category that is associated with anchors used in the shipping industry. The general KB can have knowledge about products used in the shipping industry (which may or may not include some knowledge about anchors), while the product KB will have specific information about various anchors included in the product KB.

The method 200 then proceeds from 212 to 216, where the module 107 (such as the unstructured text to KB mapping module 332 illustrated in FIGS. 1 and 3) generates one or more tuples 336, where each tuple comprises (i) the product as a subject or a head node, (ii) a correlated feature as a corresponding predicate or edge, and (iii) a corresponding identified feature value comprising a corresponding extracted phrase as a corresponding object or a tail node (e.g., as also illustrated in FIG. 3). For example, based on the use case scenario discussed with respect to FIG. 4A, a first tuple can include (blender model J1234, 1000 Watt, power), a second tuple can include (blender model J1234, 10 Amp, current), a third tuple can include (blender model J1234, too loud, noise), and a fourth tuple can include (blender model J1234, white, color). Note that the tuples 336 are generated based on phrases extracted from the unstructured texts 316.

The method 200 then proceeds from 216 to 220, where the module 107 updates the product KB 110 with the newly generated tuples 336. For example, the unstructured text to KB mapping module 332 updates the product KB 110 with the tuples 336 generated from the unstructured texts 316. As discussed, examples of the tuples 336 include (blender model J1234, 1000 Watt, power), (blender model J1234, 10 Amp, current), (blender model J1234, too loud, noise), (blender model J1234, white, color), and so on.

In some embodiments and although not illustrated in FIG. 2A, the tuples 336 can be modified prior to updating the product KB 110. For example, in one of the tuples 316, power is represented in the unit of “Watt,” where a unit of power used in the product KB 110 can be, for example, “W”. Thus, the feature value “1000 Watt” is updated to “1000 W,” prior to updating the product KB 110. Similarly, the feature “10 Amp” can be updated to “10 A,” “10 Ampere,” based on how the feature values corresponding to current rating are stored in the product KB 110.

Another example of modification of a tuple (although not relevant to the example use case of FIG. 4A) can be conversion of units, where, for example, a tuple can include a feature value in “inches,” whereas the product KB 110 stores the feature values in foot or centimeter (cm). In such an example, the feature value in inches undergo appropriate conversion, before being included in the product KB 110. In another example, a conversion of unit from 10 Amp to 10,000 mA (milli Amperes) can also occur prior to the updating.

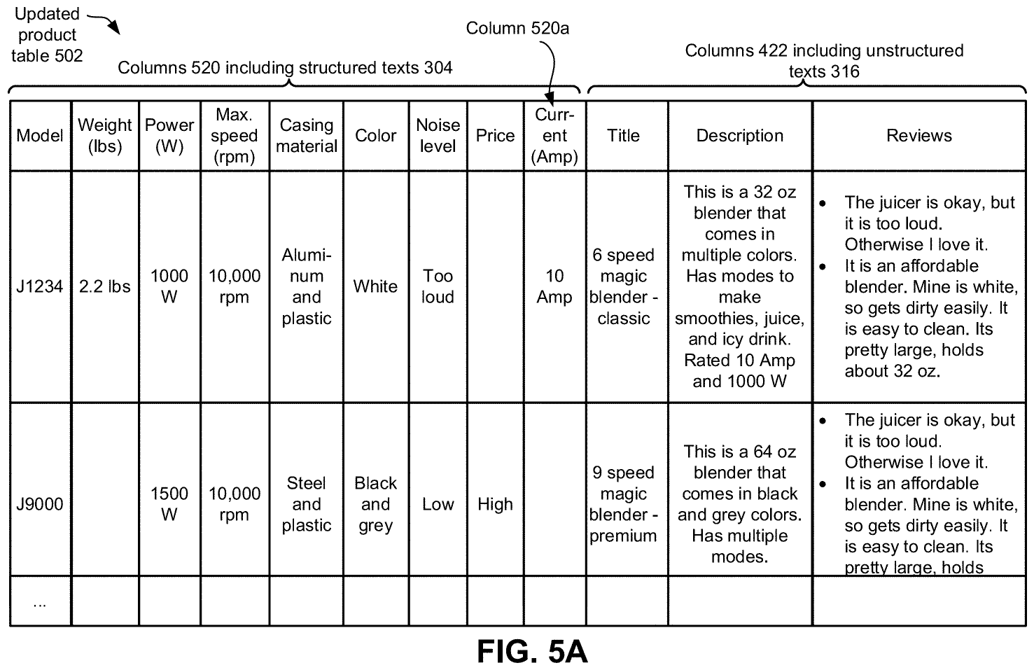

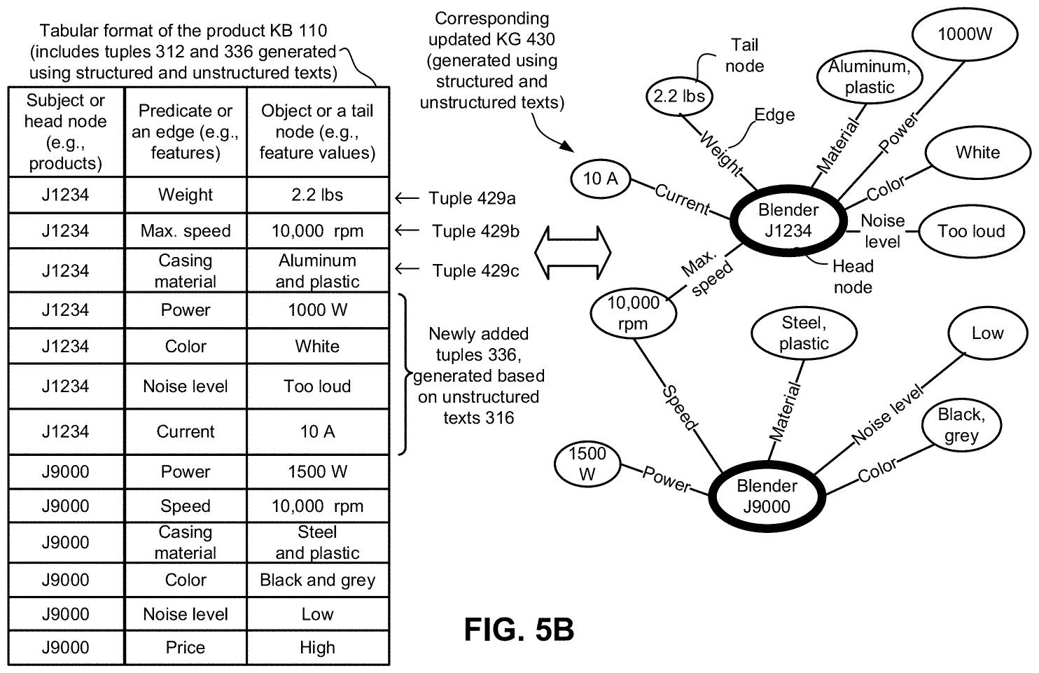

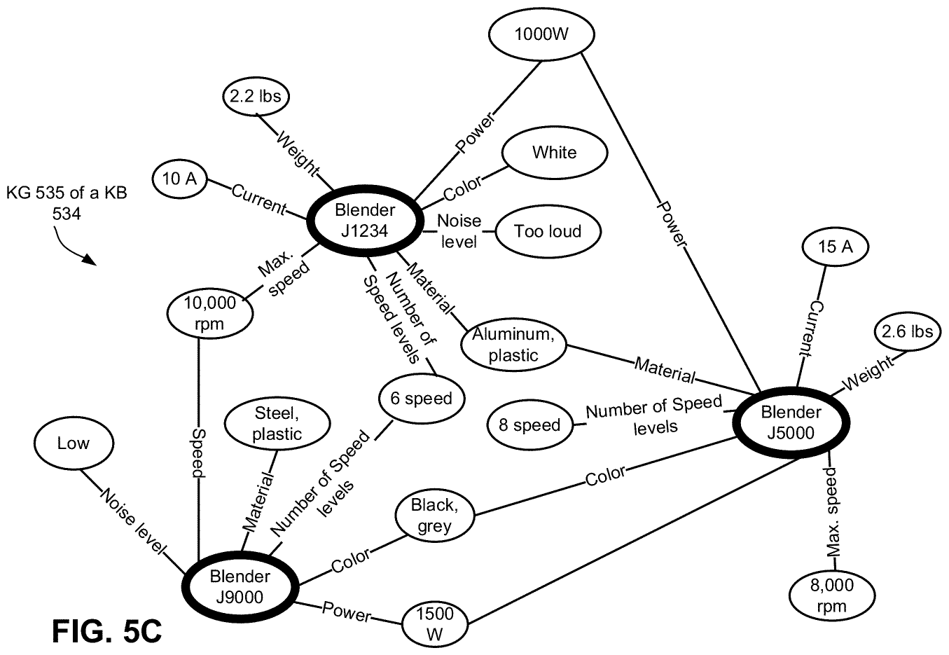

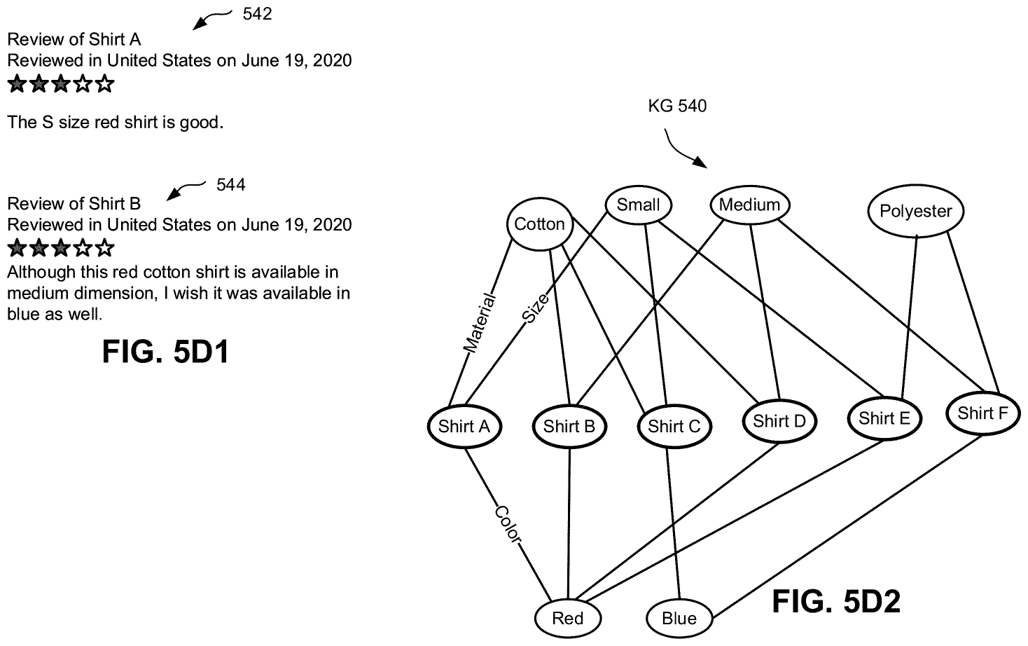

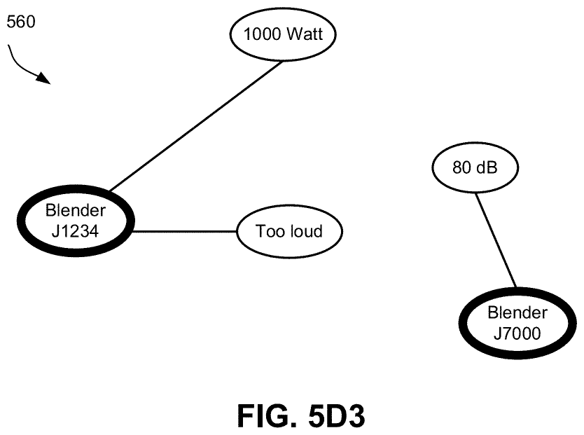

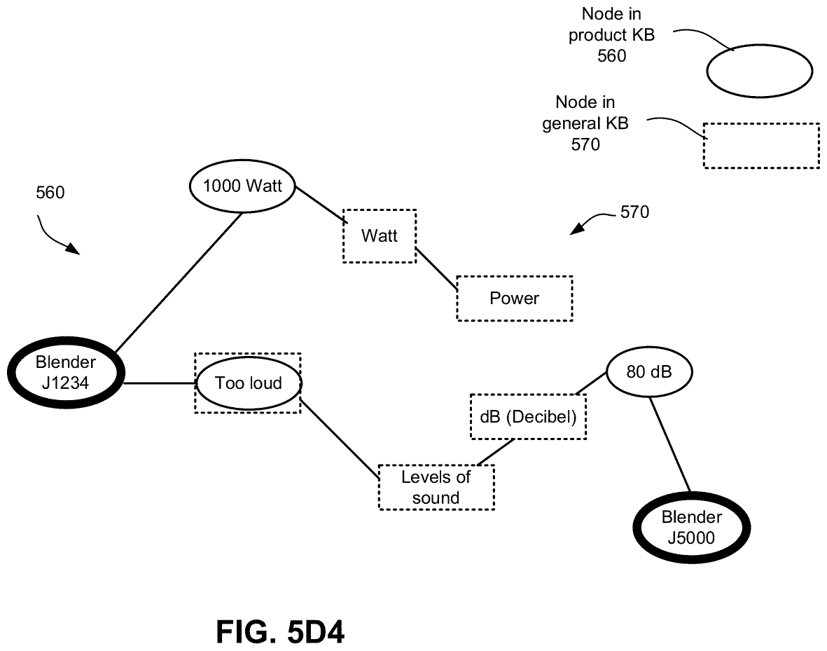

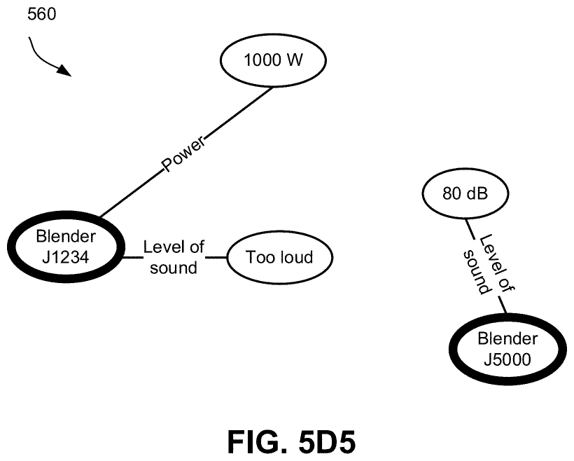

In yet another example and as will be discussed in further detail with respect to FIGS. 5D1 and 5D2, assume an example use case where every product (e.g., every shirt) included in a product KB uses “size” as a feature. If a manufacturer lists a product with “dimension” instead of “size,” the KB management system 107 realizes that “dimension” is not a listed feature. Accordingly, the KB management system 107 searches the general KB, to determine that “dimension” and “size” refer to the same feature. Accordingly, the feature name is changed from “dimension” to “size” before the corresponding feature value (such as “XL” or “L”) is added to the product KB. This way, the product KB can be used for standardization of terminology across all products within the product KB.

FIG. 5A illustrates an updated product table 502, which is updated based on the tuples 336 generated from phrases extracted from the unstructured texts 316, in accordance with some embodiments of the present disclosure. When comparing the updated product table 502 of FIG. 5A and the previous version of the product table (e.g., product table 402 of FIG. 4B), the product table 502 has a new column 520a for the feature “current”, as this new feature is now added, along with the corresponding feature value of 10 Amp, as discussed with respect to block 220 of the method 200. Similarly, the color (e.g., white), the power (e.g., 1000 W), and the noise level (e.g., “too loud”) for the product J1234 are also updated in the updated product table 502, as also discussed with respect to block 220 of the method 200.

FIG. 5B illustrates an updated product KB 110, shown in both tabular and graphical form, which is updated based on tuples 336 generated from phrases extracted from unstructured texts 316, in accordance with some embodiments of the present disclosure. When comparing the updated product KB 110 of FIG. 5A and the previous version of the product KB 110 illustrated in FIG. 4C, the updated product KB 110 now has the newly added tuples 336.

Thus, the product KB 110 and the corresponding KG 430 illustrated in FIG. 4C have tuples 312 generated from the structured text 304. On the other hand, the updated product KB 110 and the corresponding KG 430 illustrated in FIG. 5B have tuples 316 generated from the structured text 304, as well as tuples 336 generated from the unstructured text 316.

Generating and/or updating the product KB 110, using feature values from unstructured texts, makes the product KB 110 richer with relevant features. For example, without the system 102, the tuples 336 generated from the unstructured texts would not ordinarily have been present in the product KB 110. However, the system 102 is able to extract feature values from the unstructured texts and able to update the product KB 110 accordingly.

FIG. 5C illustrates an example KG 535 that is updated using tuples generated from structured and unstructured texts, in accordance with some embodiments of the present disclosure. For example, various features, such as material, weight, and color of various blenders are included in the KG 535. Specifically, the KG 535 includes three example products, such as the blenders J1234 and J9000 of FIG. 5B, and an additional blender having model number J5000. FIG. 5C will be discussed herein in turn in further detail, e.g., with respect to the method 250 of FIG. 2B.

FIG. 5D1 illustrates example unstructured texts associated with one or more products, and FIG. 5D2 illustrates a corresponding example KG 540, in accordance with some embodiments of the present disclosure. For example, various features, such as material, size, and color of various shirts are included in the KG 540. Note that only some, but not all of the edges are labelled with corresponding features, for purposes of illustrative clarity. The KG 540 includes six example products, such as six example shorts A, . . . , F. For example, shirt A has cotton as material, red as color, and small as size; shirt F has polyester as material, blue as color, and medium as size, and so on. Additional features and/or additional products can be added in the KG 540, as will be appreciated.

At least a section of the KG 540 is generated based on the unstructured texts 542 and 544 of FIG. 5D1, e.g., using the method 200 of FIG. 2. In the example of FIG. 5D1, the review 542 says that “The S size red shirt is good,” which corresponds to the “Shirt A” of the KG 540. Here, the NLP module 320 and/or the module 328 are intelligent enough to understand that “S size” refers to a “small size” of a shirt, e.g., based on searching through the general KB 111.

In another example of FIG. 5D1, the review 544 says that “Although this red cotton shirt is available in medium dimension, . . . ,” which corresponds to the “Shirt D” of the KG 540. Here, the NLP module 320 and/or the module 328 are intelligent enough to understand that “medium dimension” refers to a “medium size” of a shirt, e.g., based on searching through the general KB 111. For example, the general KB and/or the product KB use “size,” instead of “dimension” for shirts. The NLP module 320 and/or the module 328 correlate the “dimension” with the “size,” and identify these to be mere variations of the same concept, e.g., are synonyms. In an example, the tuple used to update the product KB includes a “medium size” as a feature value, instead of a “medium dimension.” That is, the feature value “medium dimension” is modified to “medium size” (or the feature name is changed from “dimension” to “size”), prior to generating the corresponding tuple and updating the product KB. Thus, as discussed, the product KB can be used for standardization of terminology.

Once a product KB for a category of products is generated and/or updated using information from structured and/or unstructured texts from corresponding product data repository, the product KB can be used for a variety of applications. For example, the product KB forms a rich database of information about the associated products, and can be used to addresses different queries about one or more associated products. FIGS. 2B, 2C, 6, 7A, and 7B illustrate some example applications of a product KB, as discussed herein below.

FIGS. 5D3-5D5 collectively illustrate an example implementation of at least some of the operations in block 208, 212, 216, and 220 of the method 200 of FIG. 2A. FIG. 5D3 illustrates a section of an example product KG 560 in which a plurality of tail nodes is updated with phrases extracted from unstructured texts (and/or possibly structured texts) and in which one or more corresponding edges are yet to be labeled, in accordance with some embodiments of the present disclosure. FIG. 5D4 illustrates the section of the example product KG 560 and a section of a general KG 570, wherein information from the general KG 570 is usable to label the edges of the section of the product KG 560, in accordance with some embodiments of the present disclosure. FIG. 5D5 illustrates the section of the example product KG 560, with the edges appropriately labeled using information from the general KG 570, in accordance with some embodiments of the present disclosure.

In more detail, and referring to FIG. 5D3, assume that phrases “1000 W” and “too loud” are extracted from unstructured texts associated with the product J1234, and assume that phrase “80 dB” is extracted from unstructured texts associated with another example product J7000. The module 107 of the system 102 doesn't yet know what these phrases represent. Accordingly, in FIG. 5D3, these phrases are added as tail nodes, and the corresponding edges are not yet populated or labeled. This implies, for example, that the module 107 does not know whether “1000 W”, “too loud,” and/or “80 dB” are feature values or not, and which corresponding features these phrases may be possibly related to. In an example, operations discussed with respect to FIG. 5D3 correspond at least in part to the operations discussed with respect to block 208 of the method 200 of FIG. 2A, where phrases are extracted from unstructured texts.

Referring to FIG. 5D4, the feature/feature value co-relation module 328 searches the general KB 570 for these phrases, or at least corresponding sections of these phrases, such as searching for “Watt” instead of “1000 W”, as discussed herein. In FIGS. 5D3-5D5, nodes of the product KB 560 are illustrated using oval shapes, whereas in FIG. 5D4 nodes of the general KB 570 are illustrated using square shapes. For example, as illustrated in FIG. 5D4, the general KB correlates Watt with power, e.g., indicates Watt to be an instance of power. Similarly, the general KB indicates “too loud” and “dB” to be instances of levels of sound. Thus, as illustrated in FIG. 5D4, the feature/feature value co-relation module 328 searches the generation KB 570 to find such correlation between individual extracted phrase and a corresponding feature. In an example, operations discussed with respect to FIG. 5D4 correspond at least in part to the operations discussed with respect to block 212 of the method 200 of FIG. 2A. For example, as discussed, the feature/feature value co-relation module 328 identifies the extracted phrase “1000 Watt” to be a feature value, and correlates the feature value “1000 Watt” with the corresponding feature “power.”

As illustrated in FIG. 5D5, now the KG 560 is updated to populate the edges. For example, now the feature/feature value co-relation module 328 has generated the tuples (J1234, power, 1000 W), (J1234, level of sound, too loud), and (J5000, level of sound, 80 dB), e.g., as discussed with respect to operations at block 216 of the method 200 of FIG. 2A. Accordingly, the edges in the KG 560 of FIG. 5D5 are updated and populated using the corresponding features, such as power and level of sound, e.g., as discussed with respect to block 220 of the method 200 of FIG. 2A. Thus, the unfinished KG 560 of FIG. 5D3 is completed in FIG. 5D5.

FIG. 2B is a flowchart illustrating an example methodology 250 for processing a search query using a product KB, in accordance with some embodiments of the present disclosure. Method 250 can be implemented, for example, using the system architecture illustrated in FIG. 1, and described herein. However other system architectures can be used in other embodiments, as apparent in light of this disclosure. To this end, the correlation of the various functions shown in FIG. 2B to the specific components and functions illustrated in FIG. 1 is not intended to imply any structural and/or use limitations. Rather, other embodiments may include, for example, varying degrees of integration wherein multiple functionalities are effectively performed by one system. In another example, multiple functionalities may be effectively performed by more than one system.

Referring to FIG. 2B, at 254 of the method 250, the system 102 accesses a product KB, which includes information associated with two or more products. Merely as an example, the product KB can be the product KB 534, and the corresponding KG 535 is illustrated in FIG. 5C.

The method 250 then proceeds from 254 to 258, where the system 102 (e.g., the query processing module 108 of the system 102, illustrated in FIG. 1) receives a search query to search for products, where the query includes one or more feature values. For example, the query input module 103 of the system 102 receives the search query via an appropriate I/O component of the device 100a, as discussed with respect to FIG. 1, such as via a tactile keyboard, a mouse, a touch sensitive or a touch-screen display (e.g., the display 142a), a trackpad, a microphone, a camera, scanner, a touch pad, and/or another appropriate type of user input. The module 103 transmits the search query to the query processing module 108 of the system 102, via the network 105.

In the example use case of the product KB 534 of FIG. 5C that includes three example blenders, the search query is about a blender. Put differently, if the search query is about a blender, the product KB 534 is used. However, if the search query is about another product (such as a bicycle), another appropriate product KB directed to such a category of product can be used instead.

The search query, in some examples, can include one or more feature values. In the context of a blender, the search query can be for searching a blender having, merely as an example, 6 speed levels and/or one or more other feature values that a user generally looks for in a blender.

The method 250 then proceeds from 258 to 262, where the system 102 (e.g., the query processing module 108 of the system 102) searches the associated product KB to identify one or more products that includes the queried feature value(s). For example, referring to FIG. 5C, the blenders J1234 and J9000 (but not the blender J5000) have 6 speed levels, where the query of the above discussed use case includes the 6 speed levels as a feature value being searched.

Also at 262, the system 102 (e.g., the query processing module 108 of the system 102) extracts information associated with the identified products from the product KB 534. For example, the system 102 extracts various feature values associated with the blenders J1234 and J9000 (but not the blender J5000, as the blender J5000 does not have the 6 speed levels).

The method 250 then proceeds from 262 to 266, where the system 102 (e.g., the query processing module 108 of the system 102) causes display of the extracted information. For example, weight, current rating, power rating, speed in rpm, material, color, noise level and/or one or more other features and their corresponding feature values of the blenders J1234 and J9000 are displayed. For example, the query processing module 108 transmits the information to the query result display module 104 of the system 101, and the query result display module 104 displays the information on the display 142a.

FIG. 2C is a flowchart illustrating an example methodology 280 for processing a comparison query using a product KB, in accordance with some embodiments of the present disclosure. Method 280 can be implemented, for example, using the system architecture illustrated in FIG. 1, and described herein. However other system architectures can be used in other embodiments, as apparent in light of this disclosure. To this end, the correlation of the various functions shown in FIG. 2C to the specific components and functions illustrated in FIG. 1 is not intended to imply any structural and/or use limitations. Rather, other embodiments may include, for example, varying degrees of integration wherein multiple functionalities are effectively performed by one system. In another example, multiple functionalities may be effectively performed by more than one system.

Referring to FIG. 2C, at 284 of the method 280, the system 102 accesses a product KB, which includes information associated with two or more products. Merely as an example, the product KB 534 and the corresponding KG 535 illustrated in FIG. 5C can be used.

The method 280 then proceeds from 284 to 288, where the system 102 (e.g., the query processing module 108 of the system 102, illustrated in FIG. 1) receives a compare query to compare at least two products, where the two products in the product KB have a first feature with a common feature value, and a second feature with two different feature values corresponding to the two products. For example, the query input module 103 of the system 102 receives the compare query via an appropriate I/O component of the device 100a, as discussed with respect to FIG. 1, such as via a tactile keyboard, a mouse, a touch sensitive or a touch-screen display (e.g., the display 142a), a trackpad, a microphone, a camera, scanner, a touch pad, and/or another appropriate type of user input. The module 103 then transmits the comparison query to the query processing module 108 of the system 102, via the network 105.

In the example user case of the product KB 534 of FIG. 5C that includes three example blenders, assume a use case scenario where the comparison query is to compare blender models J1234 and J9000. There is at least a first feature having a common feature value for the two queried products. For example, referring to FIG. 5C, as illustrated in the KG 535, both blenders are 6-speed blenders, and have 10,000 rpm maximum speed. Thus, each of the features “maximum speed” and “number of speed levels” has the same corresponding feature value for both the products.

On the other hand, there is at least a second feature that has different feature values for the two products. For example, the blenders J1234 and J9000 have low noise level and too loud noise level, respectively.

The method 250 then proceeds from 288 to 292, where the system 102 (e.g., the query processing module 108 of the system 102) searches the associated product KB and generates a comparison table comparing the two products. The comparison table has at least (i) a first row illustrating the first feature having the common feature value, and (ii) a second row illustrating the second feature having two different feature values corresponding to the two products being compared. Thus, for example, the first row illustrates the number of speed levels, and also illustrates that both blenders are 6-speed blenders. Furthermore, a second row (where the first and second rows need not be consecutive rows) illustrates that the blenders J1234 and J9000 have low noise level and too loud noise level, respectively.

The method 250 then proceeds from 292 to 296, where the system 102 (e.g., the query processing module 108 of the system 102, illustrated in FIG. 1) causes display of the comparison table. For example, the query processing module 108 transmits the comparison table to the query result display module 104 of the system 101, and the query result display module 104 displays the comparison table on the display 142a.

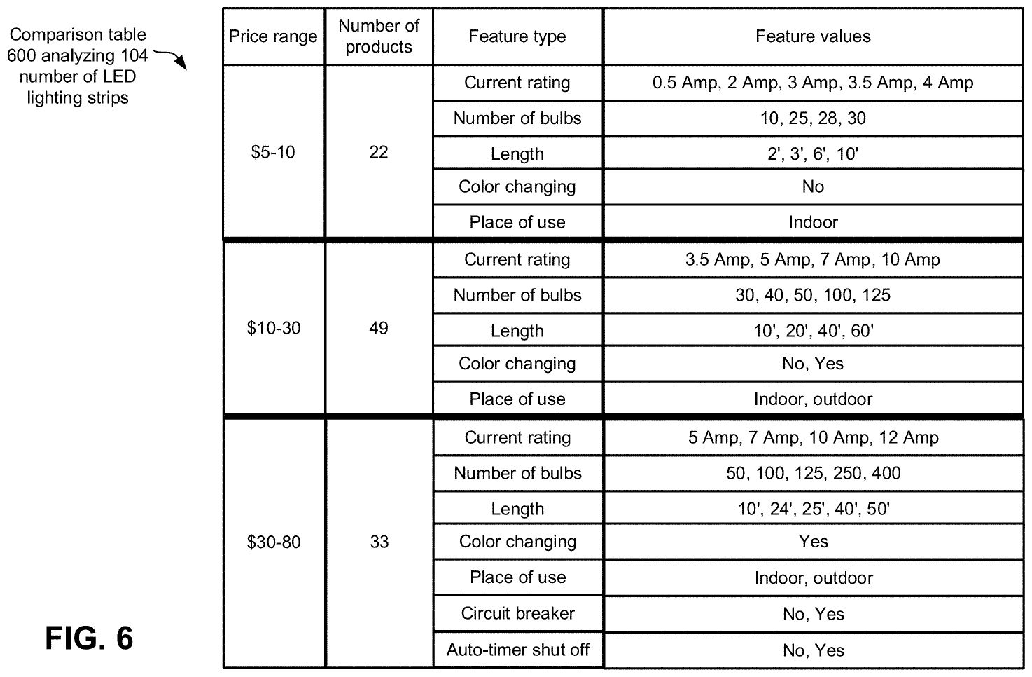

Thus, FIGS. 2A and 2B discuss some example applications of a product KB. A product KB can be used for other applications as well. For example, FIG. 6 illustrates a comparison table 600 analyzing a category of products sold on an e-commerce website, where the comparison table 600 is generated using a corresponding product KB, in accordance with some embodiments of the present disclosure. For example, the product KB used to generate the comparison table 600 is not illustrated, and generation of the comparison table 600 from the corresponding product KB will be apparent in light of this disclosure (e.g., in light of the method 200 of FIG. 2A).

Merely as an example, the comparison table 600 categorizes LED (light emitting diode) lighting stripes available for sell at an e-commerce website. Also, merely as an example, a total of 104 LED lighting stripes are categorized. A product KB and/or an associated KG is generated for these LED lighting stripes, e.g., as discussed with respect to the method 200 of FIG. 2A. The product KB is then used to generate the categorization illustrated in the comparison table 600, which is used for cluster analysis of the LED lighting strips sold by the e-commerce web site.

For example, in the comparison table 600, the available LED lighting strips are categorized in three main categories based on the price, e.g., a first category comprising LED lighting strips whose price ranges from $5-$10, a second category comprising LED lighting strips whose price ranges from $10-$30, and a third category comprising LED lighting strips whose price ranges from $30-$80. The first category has 22 products, the second category has 49 products, and the third category has 33 products.

As seen in FIG. 6, current rating of various products in the first category ranges from 0.5 Amp to 4 Amp. Similarly, products in the first category can have 10 bulbs, 25 bulbs, 28 bulbs, or 30 bulbs (e.g., at least a first product in the first category has 10 bulbs, at least a second product in the first category has 25 bulbs, at least a third product in the first category has 28 bulbs, and at least a fourth product in the first category has 30 bulbs). Various other features and corresponding feature values are also illustrated. The products in the first category are suitable for indoor use only, whereas products in the second and third categories are available for both indoor and outdoor use. Some products in the third category have additional features that are not available in the products in the first and second categories, such as presence of circuit breakers, and auto-timer shut off features. Thus, as illustrated in FIG. 6, a product KB can be used to analyze and compare various categories of products in a meaningful manner, and perform cluster analysis of the products.

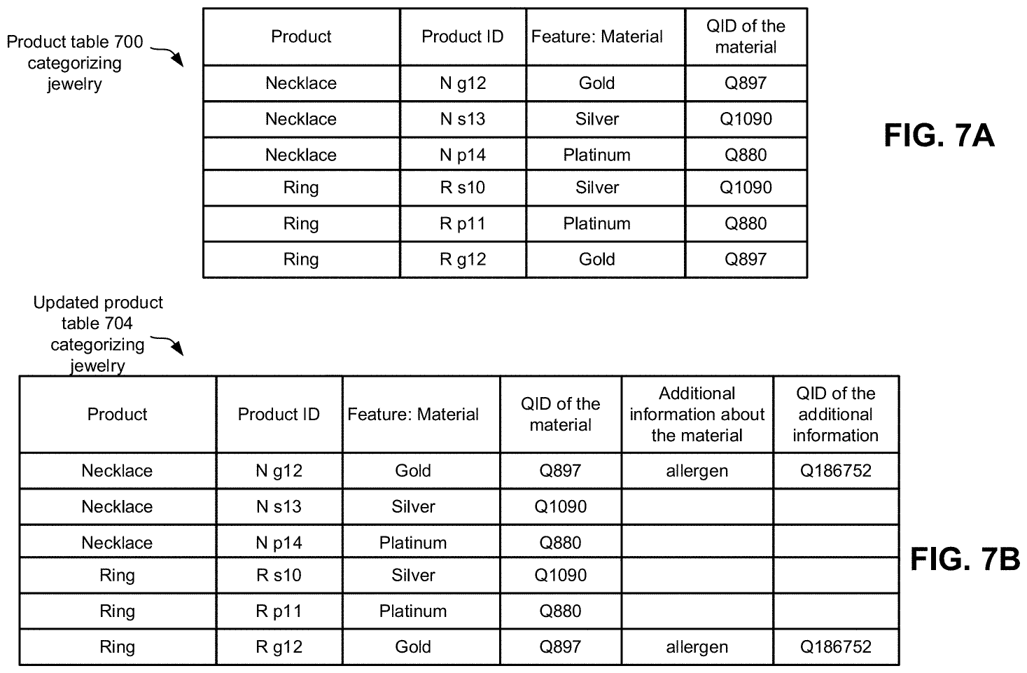

FIGS. 7A and 7B collectively illustrate an example of an expansion of a product KB, based on information received from a general KB, in accordance with some embodiments of the present disclosure. For example, referring to FIG. 7A, illustrated is a product table 700 categorizing various jewelry items. For example, a necklace having a product ID of N g12 has a “material” feature with a feature value of “gold”—that is, gold is used as a material in the necklace N g12. A unique QID of gold, which is Q897 in the Wikidata® KB, is also listed. Similarly, various other pendants and rings are also included in the product table 700. For example, silver (having a QID of Q1090) is used as a material for necklace N s13 and ring R s10, and platinum (having a QID of Q880) is used as a material for necklace N p14 and ring R p11. Although the product KB associated with the product table 700 is not illustrated, such a product KB can be generated from the product table 700, as discussed with respect to the method 200 of FIG. 2A.

In some embodiments, a general KB, such as the Wikidata® KB, is searched to find other features corresponding to the materials listed in product table 700. For example, the general KB is queried using the QID of Q897, which corresponds to gold, to determine that Q897 or gold is also an allergen. For example, some people may be allergic to gold and/or to other metals (such as nickel) usually present in trace amounts in gold used to manufacture jewelry. Accordingly, the general KB lists gold (or the corresponding QID Q897) as an allergen. Also, the feature “allergen” has a QID of Q186752, and has gold listed as a feature value. Accordingly, the product KB (although not illustrated) is updated to add a tuple comprising (i) the product N g12 necklace as a subject or a head node, (ii) the feature allergen as a corresponding predicate or edge, and (iii) the feature value gold as a corresponding object or a tail node. Similar tuple is added for the product R g12 ring as well. The product table 700 is also updated, to generate an updated product table 704 illustrated in FIG. 7B. Thus, the updated product table 704 has more information compared to the original product table 700, and includes allergen information or warning for various associated products.

Numerous variations and configurations will be apparent in light of this disclosure and the following examples.

Example 1. A method for updating and utilizing knowledge bases, the method comprising: identifying a phrase in an unstructured text that is associated with a product; identifying, based on searching a first knowledge base, the phrase to be a feature value that is associated with a corresponding feature, wherein the first knowledge base lists the feature value to be an instance of the corresponding feature; generating, in response to identifying the phrase to be the feature value, a tuple comprising (i) the product as a subject, (ii) the feature as a corresponding predicate, and (iii) the feature value comprising the phrase as a corresponding object; updating a second knowledge base with the tuple; receiving a query associated with the product; and generating a result responsive to the query, using the updated second knowledge base.

Example 2. The method of example 1, wherein the product is a first product, the tuple is a first tuple, and wherein the method further comprises: further updating the second knowledge base, such that (i) each of a first plurality of tuples of the second knowledge base includes the first product as a corresponding subject, the first plurality of tuples including the first tuple, and (ii) each of a second plurality of tuples of the second knowledge base includes a second product as a corresponding subject.

Example 3. The method of example 2, wherein the feature value is a first feature value, the feature is a first feature, the predicate is a first predicate, the object is a first object, and wherein: a second feature and a second feature value are included as a second predicate and a second object, respectively, in a second tuple of the first plurality of tuples; the second feature and the second feature value are also included as a third predicate and a third object, respectively, in a third tuple of the second plurality of tuples; and the second object and the third object overlap and form a common node of the second and third tuples.

Example 4. The method of example 3, wherein the query is a search query to find one or more products having the second feature and/or the corresponding second feature value, and generating the result responsive to the query comprises: searching the second knowledge base, to identify that each of the second tuple of the first plurality of tuples and the third tuple of the second plurality of tuples includes the second feature and the corresponding second feature value; identifying the first product as the subject in the second tuple and the second product as the subject in the third tuple; and based on identifying the first product as the subject in the second tuple and the second product as the subject in the third tuple, generating the result responsive to the query, the result including information associated with the first product and the second product.

Example 5. The method of any of examples 3 or 4, wherein the query is a comparison query to compare the first product with the second product, and generating the result responsive to the query comprises: generating the result responsive to the query, the result including a comparison table comparing the first and second products, based on the second knowledge base, wherein the comparison table comprises a first row that includes the second feature and the second feature values for both the first and second products, based on the second feature and the second feature value being included in both the second and third tuples, and wherein the comparison table further comprises a second row that includes (i) a third feature and a third feature value from a fourth tuple of the first plurality of tuples, the third feature value associated with the first product, and (ii) the third feature and a fourth feature value from a fifth tuple of the second plurality of tuples, the fourth feature value associated with the second product.

Example 6. The method of any of examples 1-5, wherein: a first version of the phrase appears in the unstructured text; a second version of the phrase appears in the first and/or second knowledge base; the first version and the second version are synonyms; and the method further comprises modifying the phrase from the first version to the second version, prior to generating the tuple.

Example 7. The method of any of examples 1-6, wherein the feature is a first feature, the tuple is a first tuple, and wherein the method further comprises: identifying, from the first knowledge base, that the feature value is also associated with a second feature; and expanding the second knowledge base by adding a second tuple that has (i) the product as a corresponding subject, (ii) the second feature as a corresponding predicate, and (iii) the feature value as a corresponding object.

Example 8. The method of any of examples 1-7, wherein identifying the phrase to be the feature value that is associated with the corresponding feature comprises: searching the first knowledge base, to identify a unique identifier associated with the phrase; querying the first knowledge base using the unique identifier; and identifying, based on querying the first knowledge base, that the phrase is an instance of the corresponding feature.

Example 9. The method of any of examples 1-8, wherein identifying the phrase in the unstructured text comprises: identifying a numerical value in the unstructured text; and identifying the numerical value, along with one or more words preceding or succeeding the numerical value, as the phrase in the unstructured text.

Example 10. The method of any of examples 1-9, wherein the unstructured text comprises a title of the product, a description of the product, a review of the product, one or more questions asked about the product, and/or one or more answers provided to such questions.

Example 11. A system for categorizing features of products, the system comprising: one or more processors; and a knowledge base management system executable by the one or more processors to identify a phrase in an unstructured text associated with a product, identify, using a first knowledge base, the phrase to be a feature value corresponding to a feature, generate a tuple comprising (i) the product as a subject, (ii) the feature as a corresponding predicate, and (iii) the feature value comprising the phrase as a corresponding object, update a second knowledge base with the tuple, receive a query about one or more products, and generate a result of the query, using the updated second knowledge base.

Example 12. The system of example 11, wherein to identify the phrase to be the feature value corresponding to the feature, the knowledge base management is to: search the first knowledge base, to identify an identifier associated with at least a part of the phrase; query the first knowledge base using the identifier; and identify, based on querying the first knowledge base, that at least the part of the phrase is an instance of the corresponding feature.

Example 13. The system of example 12, wherein: the phrase has a numerical portion and an alphabetical portion; and the knowledge base management is to search the first knowledge base using the alphabetical portion, and not the numerical portion, of the phrase.

Example 14. The system of any of examples 11-13, wherein: the first knowledge base is a general knowledge base that is not specifically associated with the product; and the second knowledge base is a domain specific knowledge base that is specifically associated with the product and one or more other products, wherein the product and one or more other products belong to a same category of products.

Example 15. The system of any of examples 11-14, wherein the feature value is a first feature value, the feature is a first feature, the tuple is a first tuple, and wherein the knowledge base management is further to: access a structured text associated with the product; identify, within the structured text, a second feature value corresponding to a second feature; generate a second tuple comprising (i) the product as a subject, (ii) the second feature as a corresponding predicate, and (iii) the second feature value as a corresponding object, wherein the first knowledge base is not used to generate the second tuple; and update the second knowledge base with the second tuple.

Example 16. The system of any of examples 11-15, wherein the unstructured text comprises a title of the product, a description of the product, a review of the product, one or more questions asked about the product, and/or one or more answers provided to such questions.

Example 17. A computer program product including one or more non-transitory machine-readable mediums encoded with instructions that when executed by one or more processors cause a process to be carried out, the process comprising: searching a text included in a description of a product, one or more reviews of the product, one or more questions about the product, and/or one or more associated answers, to identify a phrase within the text; identifying, based on querying a knowledge base, the phrase to be a feature value associated with a feature of the product; and adding, in a knowledge graph, (i) the feature value comprising the phrase as a tail node, and (ii) the feature as an edge that couples the tail node to a head node, wherein the product comprises the head node.

Example 18. The computer program product of example 17, wherein: the head node is a first head node, the tail node is a first tail node, the edge is a first edge; the first head node is coupled to a first plurality of tail nodes, the first head node coupled to each tail node of the first plurality of tail nodes by a corresponding edge of a first plurality of edges; the knowledge graph comprises a second head node coupled to a second plurality of tail nodes, the second head node coupled to each tail node of the second plurality of tail nodes by a corresponding edge of a second plurality of edges, wherein a second product comprises the second head node; and the first tail node is included in both the first and second plurality of tail nodes, such that the first tail node is directly coupled to each of the first and second head nodes.

Example 19. The computer program product of example 18, wherein the process further comprises: receiving a search query that includes the first feature value of the first tail node; identifying that the first tail node is directly coupled to each of the first and second head nodes; and generating a result of the search query, the result identifying the first and second products, based on the first tail node being directly coupled to each of the first and second head nodes.

Example 20. The computer program product of any of examples 17-19, wherein to identify the phrase to be the feature value associated with the feature, the process further comprises: identifying an identifier associated with at least a portion of the phrase in the knowledge base; querying the knowledge base using the identifier, to determine that at least the portion of the phrase is an instance of the feature of the product; and based on the querying, identifying the phrase to be the feature value associated with the feature.

The foregoing detailed description has been presented for illustration. It is not intended to be exhaustive or to limit the disclosure to the precise form described. Many modifications and variations are possible in light of this disclosure. Therefore, it is intended that the scope of this application be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method for updating and utilizing knowledge bases, the method comprising:
identifying a phrase in an unstructured text that is associated with a product;
identifying, based on searching a first knowledge base, the phrase to be a feature value that is associated with a corresponding feature, wherein the first knowledge base lists the feature value to be an instance of the corresponding feature;
generating, in response to identifying the phrase to be the feature value, a tuple comprising (i) the product as a subject, (ii) the feature as a corresponding predicate, and (iii) the feature value comprising the phrase as a corresponding object;
updating a second knowledge base with the tuple;
receiving a query associated with the product; and
generating a result responsive to the query, using the updated second knowledge base.

2. The method of claim 1, wherein the product is a first product, the tuple is a first tuple, and wherein the method further comprises:
further updating the second knowledge base, such that (i) each of a first plurality of tuples of the second knowledge base includes the first product as a corresponding subject, the first plurality of tuples including the first tuple, and (ii) each of a second plurality of tuples of the second knowledge base includes a second product as a corresponding subject.

3. The method of claim 2, wherein the feature value is a first feature value, the feature is a first feature, the predicate is a first predicate, the object is a first object, and wherein:
a second feature and a second feature value are included as a second predicate and a second object, respectively, in a second tuple of the first plurality of tuples;
the second feature and the second feature value are also included as a third predicate and a third object, respectively, in a third tuple of the second plurality of tuples; and
the second object and the third object overlap and form a common node of the second and third tuples.

4. The method of claim 3, wherein the query is a search query to find one or more products having the second feature and/or the corresponding second feature value, and generating the result responsive to the query comprises:
searching the second knowledge base, to identify that each of the second tuple of the first plurality of tuples and the third tuple of the second plurality of tuples includes the second feature and the corresponding second feature value;
identifying the first product as the subject in the second tuple and the second product as the subject in the third tuple; and
based on identifying the first product as the subject in the second tuple and the second product as the subject in the third tuple, generating the result responsive to the query, the result including information associated with the first product and the second product.

5. The method of claim 3, wherein the query is a comparison query to compare the first product with the second product, and generating the result responsive to the query comprises:
generating the result responsive to the query, the result including a comparison table comparing the first and second products, based on the second knowledge base,
wherein the comparison table comprises a first row that includes the second feature and the second feature values for both the first and second products, based on the second feature and the second feature value being included in both the second and third tuples, and
wherein the comparison table further comprises a second row that includes (i) a third feature and a third feature value from a fourth tuple of the first plurality of tuples, the third feature value associated with the first product, and (ii) the third feature and a fourth feature value from a fifth tuple of the second plurality of tuples, the fourth feature value associated with the second product.

6. The method of claim 1, wherein:
a first version of the phrase appears in the unstructured text;
a second version of the phrase appears in the first and/or second knowledge base;
the first version and the second version are synonyms; and
the method further comprises modifying the phrase from the first version to the second version, prior to generating the tuple.

7. The method of claim 1, wherein the feature is a first feature, the tuple is a first tuple, and wherein the method further comprises:
identifying, from the first knowledge base, that the feature value is also associated with a second feature; and
expanding the second knowledge base by adding a second tuple that has (i) the product as a corresponding subject, (ii) the second feature as a corresponding predicate, and (iii) the feature value as a corresponding object.

8. The method of claim 1, wherein identifying the phrase to be the feature value that is associated with the corresponding feature comprises:
searching the first knowledge base, to identify a unique identifier associated with the phrase;
querying the first knowledge base using the unique identifier; and
identifying, based on querying the first knowledge base, that the phrase is an instance of the corresponding feature.

9. The method of claim 1, wherein identifying the phrase in the unstructured text comprises:
identifying a numerical value in the unstructured text; and
identifying the numerical value, along with one or more words preceding or succeeding the numerical value, as the phrase in the unstructured text.

10. The method of claim 1, wherein the unstructured text comprises a title of the product, a description of the product, a review of the product, one or more questions asked about the product, and/or one or more answers provided to such questions.

11. A system for categorizing features of products, the system comprising:
one or more processors; and
a knowledge base management system executable by the one or more processors to
identify a phrase in an unstructured text associated with a product,
identify, using a first knowledge base, the phrase to be a feature value corresponding to a feature,
generate a tuple comprising (i) the product as a subject, (ii) the feature as a corresponding predicate, and (iii) the feature value comprising the phrase as a corresponding object,
update a second knowledge base with the tuple,
receive a query about one or more products, and
generate a result of the query, using the updated second knowledge base.

12. The system of claim 11, wherein to identify the phrase to be the feature value corresponding to the feature, the knowledge base management is to:
search the first knowledge base, to identify an identifier associated with at least a part of the phrase;
query the first knowledge base using the identifier; and
identify, based on querying the first knowledge base, that at least the part of the phrase is an instance of the corresponding feature.

13. The system of claim 12, wherein:
the phrase has a numerical portion and an alphabetical portion; and
the knowledge base management is to search the first knowledge base using the alphabetical portion, and not the numerical portion, of the phrase.

14. The system of claim 11, wherein:
the first knowledge base is a general knowledge base that is not specifically associated with the product; and
the second knowledge base is a domain specific knowledge base that is specifically associated with the product and one or more other products, wherein the product and one or more other products belong to a same category of products.

15. The system of claim 11, wherein the feature value is a first feature value, the feature is a first feature, the tuple is a first tuple, and wherein the knowledge base management is further to:
access a structured text associated with the product;
identify, within the structured text, a second feature value corresponding to a second feature;
generate a second tuple comprising (i) the product as a subject, (ii) the second feature as a corresponding predicate, and (iii) the second feature value as a corresponding object, wherein the first knowledge base is not used to generate the second tuple; and
update the second knowledge base with the second tuple.

16. The system of claim 11, wherein the unstructured text comprises a title of the product, a description of the product, a review of the product, one or more questions asked about the product, and/or one or more answers provided to such questions.

17. A computer program product including one or more non-transitory machine-readable mediums encoded with instructions that when executed by one or more processors cause a process to be carried out, the process comprising:
searching a text included in a description of a product, one or more reviews of the product, one or more questions about the product, and/or one or more associated answers, to identify a phrase within the text;
identifying, based on querying a knowledge base, the phrase to be a feature value associated with a feature of the product; and
adding, in a knowledge graph, (i) the feature value comprising the phrase as a tail node, and (ii) the feature as an edge that couples the tail node to a head node, wherein the product comprises the head node.

18. The computer program product of claim 17, wherein:
the head node is a first head node, the tail node is a first tail node, the edge is a first edge;
the first head node is coupled to a first plurality of tail nodes, the first head node coupled to each tail node of the first plurality of tail nodes by a corresponding edge of a first plurality of edges;
the knowledge graph comprises a second head node coupled to a second plurality of tail nodes, the second head node coupled to each tail node of the second plurality of tail nodes by a corresponding edge of a second plurality of edges, wherein a second product comprises the second head node; and
the first tail node is included in both the first and second plurality of tail nodes, such that the first tail node is directly coupled to each of the first and second head nodes.

19. The computer program product of claim 18, wherein the process further comprises:
receiving a search query that includes the first feature value of the first tail node;
identifying that the first tail node is directly coupled to each of the first and second head nodes; and
generating a result of the search query, the result identifying the first and second products, based on the first tail node being directly coupled to each of the first and second head nodes.

20. The computer program product of claim 17, wherein to identify the phrase to be the feature value associated with the feature, the process further comprises:
identifying an identifier associated with at least a portion of the phrase in the knowledge base;
querying the knowledge base using the identifier, to determine that at least the portion of the phrase is an instance of the feature of the product; and
based on the querying, identifying the phrase to be the feature value associated with the feature.
